(19) United States
(12) Patent Application Publication
(10) Pub. No.: US 2012/0278127 A1
(43) Pub. Date: Nov. 1, 2012

(54) GENERATING PRODUCT RECOMMENDATIONS BASED ON DYNAMIC PRODUCT CONTEXT DATA AND/OR SOCIAL ACTIVITY DATA RELATED TO A PRODUCT

(75) Inventors: Artem Kirakosyan, St. Petersburg (RU); Ilya Oskolkov, Moscow (RU); Rodion Shishkov, St. Petersburg (RU); Igor Sokolov, Tver (RU)

(73) Assignee: RAWLLIN INTERNATIONAL INC., Tortola (VI)

(21) Appl. No.: 13/096,790

(22) Filed: Apr. 28, 2011

(51) Int. Cl. G06Q 30/00

(52) U.S. Cl. 705/7.29; 705/26.1; 705/347; 705/26.7; 705/26.61

(57) ABSTRACT

Systems and methods are described for generating online product recommendations. A plurality of data objects representative of a plurality of items for user consumption from an online merchant are stored at a computing device. A method then comprises, registering a device associated with a user with the online merchant; and in response to registering the device: associating the device with at least one other device registered with the online merchant associated with an other user in response to selection of the at least one other device by the device, monitoring a first social activity of the at least one other device, wherein the first social activity includes a first activity related to an interaction of the at least one other device with at least one of the plurality of data objects, and collecting and storing first social activity data related to the first social activity of the at least one other device.

### TECHNICAL FIELD

This disclosure relates generally to facilitating and generating product recommendations based on dynamic product context data and/or social activity data related to a product.

### BACKGROUND

Recommendation systems include data search methods that are designed to provide suggestions of items (products, services, information, etc.) from large pools of data that are likely to be of interest to the searchers based on their preferences. The volume and complexity of Internet data has made recommendation systems beneficial tools for users in online browsing and shopping. Such systems help seekers to save time spent on researching for information and managing streams of information by suggesting relevant data. Today, many e-commerce web spaces are employing various types of recommendation functionality intended to assist their visitors in making better choices with reduced effort while browsing for products.

There are three fundamental recommendation service approaches. The first two include computer-implemented recommendation systems and the third includes manual analysis information filtering techniques. Computer-implemented systems typically compare a user profile to some reference characteristics, seek to predict the ‘“rating” that the user would give to an item they had not yet considered, and present an abridged results list to the user based on the prediction. Reference characteristics may be obtained from the item description, which is the content-based approach or the collective ratings of others regarding the item, which is the collaborative filtering approach. In an example collaborative filtering approach, recommendations are made based on a user's past likes and dislikes as compared to the choices of other users making similar valuations. On the other hand, the manual analysis approach typically employs a system where users are presented with an unabridged catalogue item list with item ranking and review information embedded next to each item listing. The recommendation seekers are then forced to make individual conclusions about the relevance and quality of a product review provided by another when selecting a product.

Although existing computer-implemented recommendation systems offer assistance in helping consumers with product research, each technique is aimed to fulfill a specific narrow objective such as recommending items similar to a search query, recommending an item similar to characteristics known about the user, or presenting a user with searched items characteristics allowing the users independently make a decision regarding the item. Thus, the existing systems fail to provide a universal and complete effective search tool.

Additionally, even if it were possible to combine all three systems, each system independently has several limitations. For example, content-based methods generally do not provide a mechanism for evaluating the quality or popularity of an item. In addition, content-based methods generally require that the items include some form of content that is amenable to feature extraction algorithms. As a result, content-based systems tend to be poorly suited for recommending products and other types of items that have limited and useless searchable content.

Collaborative filtering techniques fill some of the gaps of the content-based methods by employing an underlying assumption that those who agreed in the past tend to agree again in the future. Collaborative filtering techniques provide predictions specific to a user based on information gleaned from many users. Collaborative filtering differs from a simpler approach that comprises giving an average (non-specific) score for each item of interest based on ratings. For example, a collaborative recommendation system for television tastes could make predictions about which television show a user should like given a partial list of that user's tastes, likes or dislikes. However, as with content-based filtering methods, existing collaborative filtering techniques have several problems. One problem is that users of online stores frequently do not take the time to explicitly rate the products or create lists of their favorite products. As a result, the online merchant may be able to provide personalized product recommendations to only a small segment of its consumers.

Furthermore, an item normally cannot be recommended by collaborative filtering techniques until a threshold quantity of ratings data has been collected. As a result, the users of collaborative recommendation system are deprived of an opportunity to receive information on newly added or off-main stream items. Further, even if a user takes the time to set up a profile, the recommendations thereafter provided to the user typically will not take into account the user's short term browsing interests. For example, the recommendations may not be helpful to a user who is purchasing a gift for another user or who is venturing into an unfamiliar product category.

Another problem with collaborative filtering methods is that the task of comparing user profiles tends to be time consuming, particularly if the number of users is large (e.g., tens or hundreds of thousands). As a result, a trade-off tends to exist between response time and breadth of analysis. For example, in a recommendation system that generates real-time recommendations in response to requests from users, it may not be feasible to compare the user's ratings profile to those of all other users. A relatively shallow analysis of the available data may therefore be performed leading to poor recommendations. Although manually reviewing users collaboratively submitted item's rankings and reviews provides a general guideline in item quality assessment, it could hardly be respected as a standalone recommendation technique, as this approach is time consuming and heavily dependent on the tastes of individual users, which may not necessarily be shared.

Yet, another problem with both computer-implemented and manual recommendation approaches is that they generally do not reflect current user preferences. Therefore, there is a need for a system and method which combines the advantages of all three systems while accounting for the disadvantages of each system standing alone.

The above-described deficiencies of conventional recommendation systems are merely intended to provide an overview of some of problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject disclosure. Its sole purpose is to present some concepts of the disclosed subject matter in a simplified form as a prelude to the more detailed description presented later.

To correct for the above noted deficiencies of conventional recommendation techniques and other drawbacks of current online recommendation technologies, various systems, methods, and apparatus described employ dynamic product context data and/or social activity data related to the product to generate product recommendations. For example, a method is provided comprising storing, by at least one computing device, a plurality of data objects representative of a plurality of items for user consumption from an online merchant, associating each of the plurality of data objects with context data including content data, user preference data and aggregated other user preference data, and generating a subset of the plurality of data objects based on the context data. The method can further comprise, storing the context data by the at least one computing device, receiving new context data and dynamically updating the context data based on the new context data in response to the receiving. In addition, the method can further comprise filtering the plurality of data objects or the subset of the plurality of data objects based on at least one user defined criterion encompassed by the context data.

Another method is provided comprising accessing, by at least one computing device, a plurality of data objects representative of a plurality of items for consumption by a user from an online merchant, wherein each of the plurality of data objects are associated with context data including content data, user preference data and aggregated other user preference data, requesting a first subset of the plurality of data objects based on the context data, and receiving a computer generated output including the first subset of the plurality of data objects. In an aspect of the above method further comprises dynamically updating the context data based on new context data in response to receiving the new context data. In addition, the method of claim can further comprise selecting at least one searchable criterion related to the context data, requesting a second subset of the plurality of data objects based on the criterion, and wherein the receiving the computer generated output includes receiving the second subset of the plurality of data objects.

Yet in another aspect, provided is a system comprising a data store configured to store a plurality of data objects representative of a plurality of items for consumption by a user from an online merchant, wherein each of the plurality of data objects include context data including content data, user preference data and aggregated other user preference data, and a recommendation component configured to generate a subset of the plurality of data objects based on the context data. The system can further comprise an update component configured to receive new context data and dynamically update the context data in the data storage based on the new context data. In addition, the system can comprise a filter component configured to filter the plurality of data objects or the subset of the plurality of data objects based on at least one user defined criterion.

Further provided is a method comprising storing by a computing device, a plurality of data objects representative of a plurality of items for user consumption from an online merchant, registering a device associated with a user with the online merchant; and in response to registering the device: associating the device with at least one other device registered with the online merchant associated with an other user in response to selection of the at least one other device by the device, monitoring a first social activity of the at least one other device, wherein the first social activity includes a first activity related to an interaction of the at least one other device with at least one of the plurality of data objects, and collecting and storing first social activity data related to the first social activity of the at least one other device. The method can further comprise employing a computer to generate a subset of the plurality of data objects based on the first social activity data.

Another method is provided comprising, accessing by a computing device associated with a user, a plurality of data objects representative of a plurality of items for user consumption from an online merchant, registering the device associated with the online merchant; and in response to the registering: selecting by the device, at least one other device registered with the online merchant associated with an other user as friend, requesting a first subset of the plurality of data objects based on first social activity data, wherein the first social activity data includes data related to a first activity of the least one other device's interaction with at least one of the plurality of data objects, and outputting the first subset. The method can further comprise requesting a second subset of the plurality of data objects based on the first social activity data and at least second social activity data, wherein the second social activity includes data related to a second activity of the least one other device's interaction with at least one of the plurality of data objects, and wherein the outputting includes outputting the subset of the plurality of data objects based on the first social and second activity data.

In addition, provided is a system comprising a data store configured to store a plurality of data objects representative of a plurality of items for user consumption from an online merchant, an authorization component configured to register a device associated with a user with the online merchant, a friend component configured to associate the registered device with at least one other device registered with the online merchant associated with an other user in response to selection of the at least one other device by the device, and a monitoring component configured to monitor social activities of the at least one other device, wherein the social activities include different social activities related to an interaction by the at least one other device with at least one of the plurality of data objects, the monitoring component further configured to collect and store social activity data related to each of the different social activities monitored. The system can further include a recommendation component configured to employ a computer to generate a subset of the plurality of data objects based on at least a part of the social activity data.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a block diagram of an item recommendation system in accordance with an embodiment.

FIG. 2 illustrates a block diagram of an item recommendation in accordance with another embodiment.

FIG. 3 illustrates an exemplary non-limiting embodiment of a social graph of interconnected members.

FIG. 4-5 illustrate various processes for generating and receiving a recommendation in accordance to an embodiment.

FIGS. 6 and 7 illustrate example views of one or more aspects of a shopping portal when presented to a user as a webpage.

FIG. 8 illustrates a process of user authorization by an item recommendation system in accordance with an embodiment.

FIG. 9 illustrates a block diagram of an item recommendation in accordance with another embodiment.

FIGS. 10-12 illustrate various processes for generating and receiving a recommendation in accordance with an embodiment.

FIG. 13 presents an example view of one or more aspects of a shopping portal when presented to a user as a webpage.

FIG. 14A presents a view of a user's friend's list components in accordance with an embodiment.

FIG. 14B presented is a flow diagram for navigating in another user's bag in accordance with an embodiment.

FIG. 15 presents various components of a brief item description in accordance with an embodiment.

FIG. 16 presents a flow diagram for recommending an item in accordance with an embodiment.

FIG. 17A presents a flow diagram for selecting a friend affiliated with a social network as a recipient of a recommendation in accordance with an embodiment.

FIG. 17B presents a flow diagram for selecting a friend who is a member registered with the shopping portal, as a recipient of a recommendation in accordance with an embodiment

FIG. 18A presents a flow diagram for sending a recommendation to a recipient via an email in accordance with an embodiment.

FIG. 18B presents a diagram of view of a shopping portal that facilitates a user when searching for new friends.

FIG. 19 presents a flow diagram illustrating the process of linking a registered user's affiliated SN account profile data to that of his/her SP account in accordance with an embodiment.

FIGS. 20A and 20B present flow diagrams illustrating processes of searching for a service member according to various embodiments.

FIG. 21 presents a flow diagram illustrating a process of a user inviting an individual who is a friend on an external SN to join the SP network in accordance with an embodiment.

FIG. 22A presents a flow diagram illustrating a process of adding a user to a SP friends list in accordance with an embodiment.

FIG. 22B presents a flow diagram illustrating a process of removing a user from a SP friends list in accordance with an embodiment

FIG. 23A presents a flow diagram illustrating a process of setting a rating of an item and item category in accordance with an embodiment.

FIG. 23B presents a flow diagram illustrating a process of submitting a review of an item and item category in accordance with an embodiment.

FIG. 24 presents a flow diagram illustrating a process of writing a comment to an item or item category review in accordance with an embodiment

FIG. 25 illustrates a block diagram representing exemplary non-limiting networked environments in which various non-limiting embodiments described herein can be implemented.

FIG. 26 illustrates a block diagram representing an exemplary non-limiting computing system or operating environment in which one or more aspects of various non-limiting embodiments described herein can be implemented.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

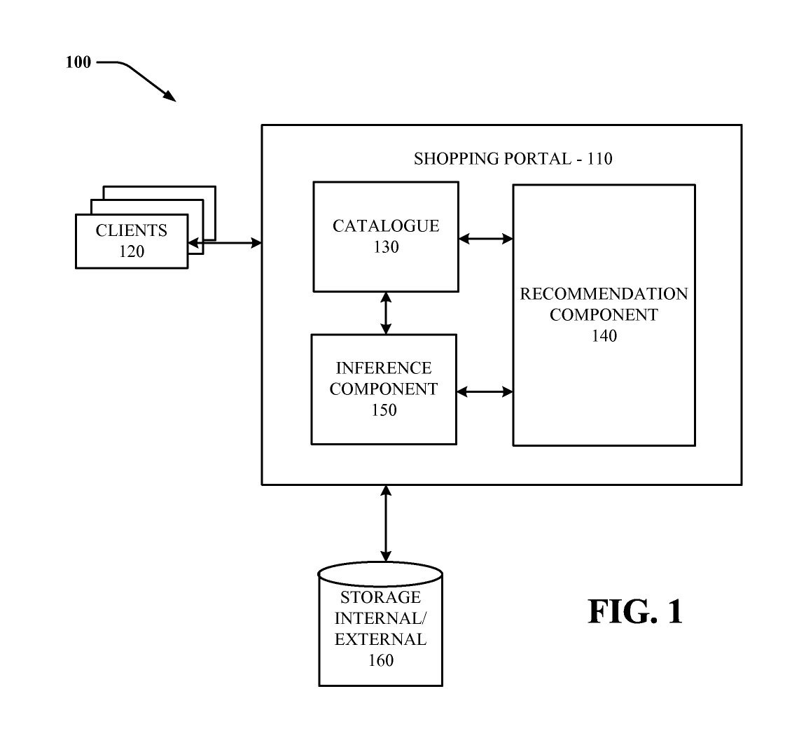

Referring now to FIG. 1, illustrated is a block diagram of an item recommendation system 100, in accordance with an embodiment. Aspects of item recommendation system 100, and systems, other apparatus, and processes explained herein can constitute machine-executable instructions embodied within machine(s), e.g., embodied in one or more computer readable mediums (or media) associated with one or more machines. Such instructions, when executed by the one or more machines, e.g., computer(s), computing device(s), virtual machine(s), etc. can cause the machine(s) to perform the operations described.

As seen in FIG. 1, item recommendation system 100 includes a shopping portal 110 that includes a catalogue 130, a recommendation component 140, and an inference component 150. The shopping portal is further coupled to data storage 160. The data storage 160 can include an internal data store or an external data store. One or more clients or users 120 can interface with the shopping portal via one or more devices. As used herein a “user” includes an individual associated with a client device who uses at least one feature of the shopping portal 160. As discussed infra, a user can include a registered user or an unregistered user.

In an aspect, on online merchant employs the item recommendation system 100 to facilitate purchases. The shopping portal 110 is on online shopping system associated with an online merchant. The shopping portal 110 can reside on a server computer that is accessible by a client 120 via a client computer. For example clients 120 can interface with the shopping portal 110 via a computing device including but not limited to a cellular phone, a smart-phone, an interactive television, a personal digital assistant (PDA), a tablet processing computer (PC), a laptop computer, a gaming device, or a home computer. It should be appreciated that additional communicating and computing devices may arise, all of which should be considered compatible additions within the architecture of the systems and methods of the subject disclosure.

A client computer interfaces with the shopping portal 110 via an interactive web page. For example a page, such as a hypertext mark-up language (HTML) page, can be displayed at a client device and is programmed to be responsive to a user selecting one or more elements displayed on the page. It is noted that although the embodiments and examples will be illustrated with respect to an architecture employing HTML pages and the World Wide Web, the embodiments and examples may be practiced or otherwise implemented with any network architecture utilizing clients and servers, and with distributed architectures, such as but not limited to peer to peer systems.

In an aspect, the shopping portal 110 presents a plurality of items for user consumption. The items are represented as data objects representative of the items. The shopping portal can employ data store 160 in order to store the data objects associated with the items. In one aspect the shopping portal 110 stores the plurality of item in the catalogue 130. For example, the catalogue 130 can present a searchable list of items. It should be appreciated that the catalogue 160 can employ a variety of organizational schemes in order to facilitate browsing for an item. For example, the catalogue 160 can organize the items into a variety of searchable item categories. Shopping portal 110 can further include elements and features associated with traditional online merchants. For example, the shopping portal can allow a client 120 to select products for purchase and purchase products. In another aspect, the shopping portal can employ a recommendation component 140 in order to facilitate selection and purchasing of products.

Data storage 160 can be configured to store the plurality of items for user consumption available from the online merchant. It should be appreciated that a variety items can be considered an item for user consumption. For example, the items can include tangible goods, intangible goods, offers and/or services. Data storage 160 is further configured to store context data associated with each item or item category. In an aspect, context data includes content data, user preference data, and aggregated user preference data.

As used herein, content data includes elements of an item that are constant and/or assigned to an item by a provider of the item. For example, content data can include an item's name, title or price. According to the subject example, the name or title can be constant elements associated with the item, such as the name of a movie or a book, and the price can be defined by the provider of the item. In an aspect, content data can also include data related to an item's physical features. Content data can also include definitional features such as a film's year or release date, genre, or director. Further content data defined by the provider can include promotions and/or offers related to the item. The particular content data associated with an item and stored in data storage 160 can be selected by the merchant or shopping portal administrator, thus allowing for flexibility in the amount of content data associated with an item. For example, the content data for an item can be limited to the title of the item or can include multiple features and elements of the item.

As used herein, user preference data includes data related to a user's affinity for an item. As noted above, a user includes an individual associated with a client device who uses at least one feature of the shopping portal 110. As discussed infra, a user can include a registered user or an unregistered user. In an embodiment, user preference data is provided by the user himself/herself. For example, user preference data can include but is not limited to a user's personal rating of an item or a user's personal evaluation or description of an item. In another example, user preference data can include items or categories of items a user likes or dislikes and the degree of the user's liking or disliking. In another aspect, user preference data can include data related to a user's affinity for an item generated by an inference component 150 on behalf of the user.

In an aspect, inference component 150 is configured to make a determination of a user's preference/affinity for an item based on a user profile or a user's social map. Inference component 150 employs explicitly and/or implicitly trained classifiers in connection with performing inference and/or probabilistic determinations and/or statistical-based determinations as in accordance with one or more aspects of the disclosed subject matter as described herein. For example, the inference component 150 can employ a user profile and/or a user social map and automatically determine user preference data including at least one of a user's personal rating of an item, whether a user likes or dislikes an item, or detailed reviews or evaluations of an item likely to be supplied by the user. The inference component can further associate the computer generated personal preference data with an item and store the computer generated personal preference data in data storage 160.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As discussed above, inference component 150 can automatically determine user preference data based on a user profile and/or a user's social map. Thus in an aspect, a user can provide a user profile which can be stored in data storage 160. A user profile can include a variety of data provided by the user which can facilitate associating an item with a user. For example, a user profile can include a list of criterion related to a user's general likes and dislikes including but not limited to: the types of items a user likes, qualities of items the user likes, the categories of items a user likes, minimum item rating requirements, item pricing requirements, user location, shipping requirements, etc. In addition, a user profile can include information related to a user's hobbies, habits, activities, job, salary, or travel plans/aspirations.

According to another embodiment, inference component 150 can generate user preference data based on a social graph of a user. In an aspect, social graph data for a user can be stored in data storage 160. A user's social graph refers to a user's connections and relationships pertinent to that user. Social graph is a term coined by those working in the social areas of graph theory. It has been described as data structure(s) representing “the global mapping of everybody and how they're related.” Online social networks take advantage of social graphs by examining the relationships between individuals to offer a richer online experience.

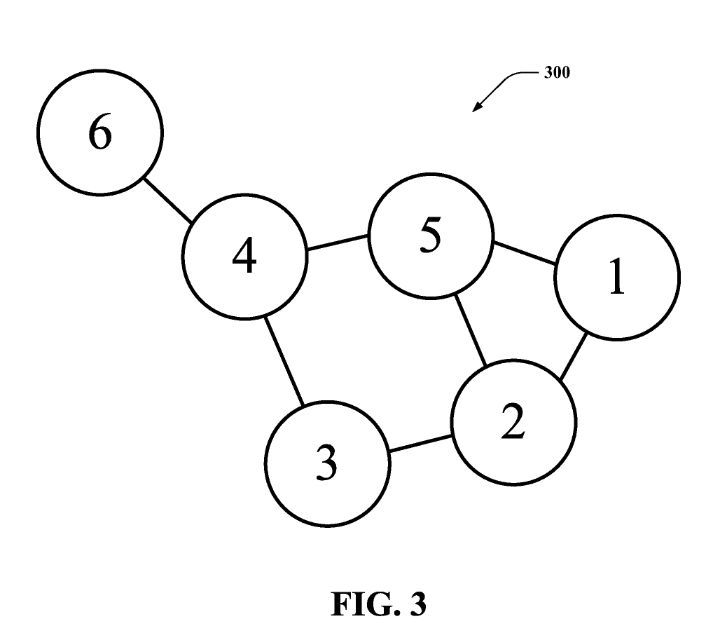

In this regard, while a graph is an abstract concept used in discrete mathematics, a social graph describes the relationships between individuals online, e.g., a representation or description of relationships in the real world. A social graph is a sociogram that represents personal relations. In this regard, a social graph is a data representation, and can be defined explicitly by its associated connections, and stored in or across computer memory(ies). Social graph information can be exposed to websites, applications and services in order to take advantage of the rich information, e.g., demographic information, embodied by the graph information and associated data and metadata about the individuals comprising the graph. Example members 1, 2, 3, 4, 5 and 6 of an exemplary non-limiting social graph 300 of interconnected members are depicted in FIG. 3.

The concept of a social graph is not limited to just interconnections of people, but rather websites, applications and services can draw information about various objects and information, e.g., photos, audio, events, web pages, etc. and their relationships. This expands the social graph concept to more than just relationships between individuals and instead applies it to virtual non-human objects between individuals, as well. Thus according to another aspect, a user's social graph refers to a user's connections related to virtual non-human objects.

Social map data can be homegrown or sourced from third parties, or a combination. For instance, any third party social networks and other online spaces where user interactions is permitted can be leveraged for social mapping information related to a given social graph, such as product discussion forums, fan sites, product news sites, online product databases, online recommendation and references sites, dictionaries, wikis, user blogs', search engines, decision guides, search engines, social network services, etc. Information exchange with social networks can be implemented through open authorization protocol.

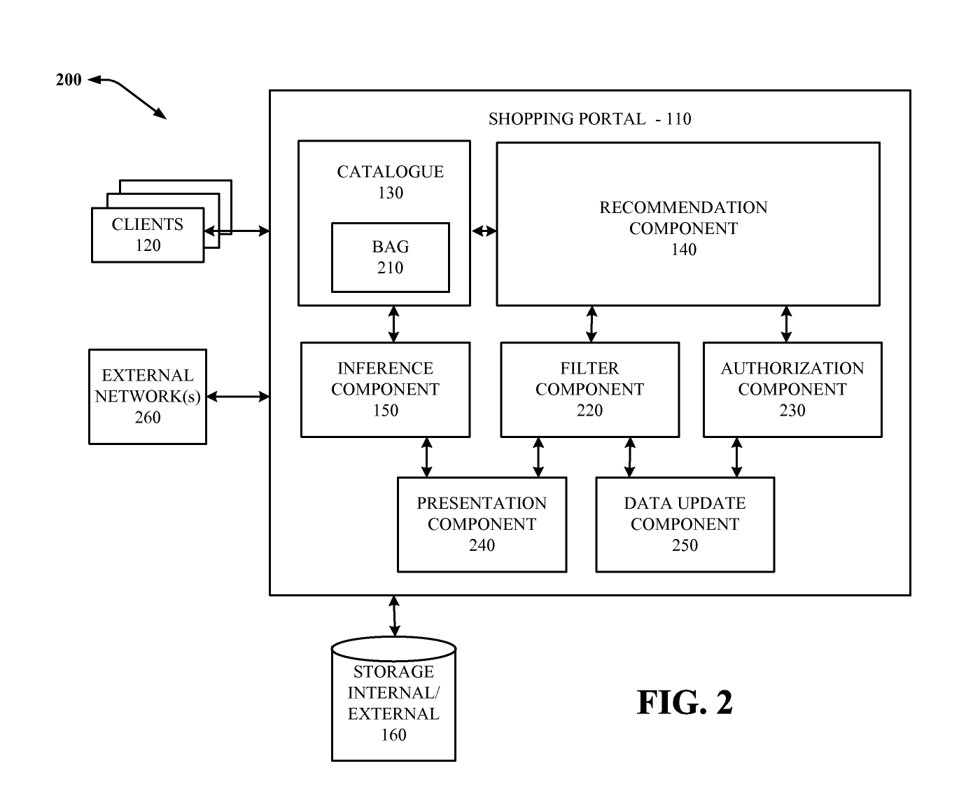

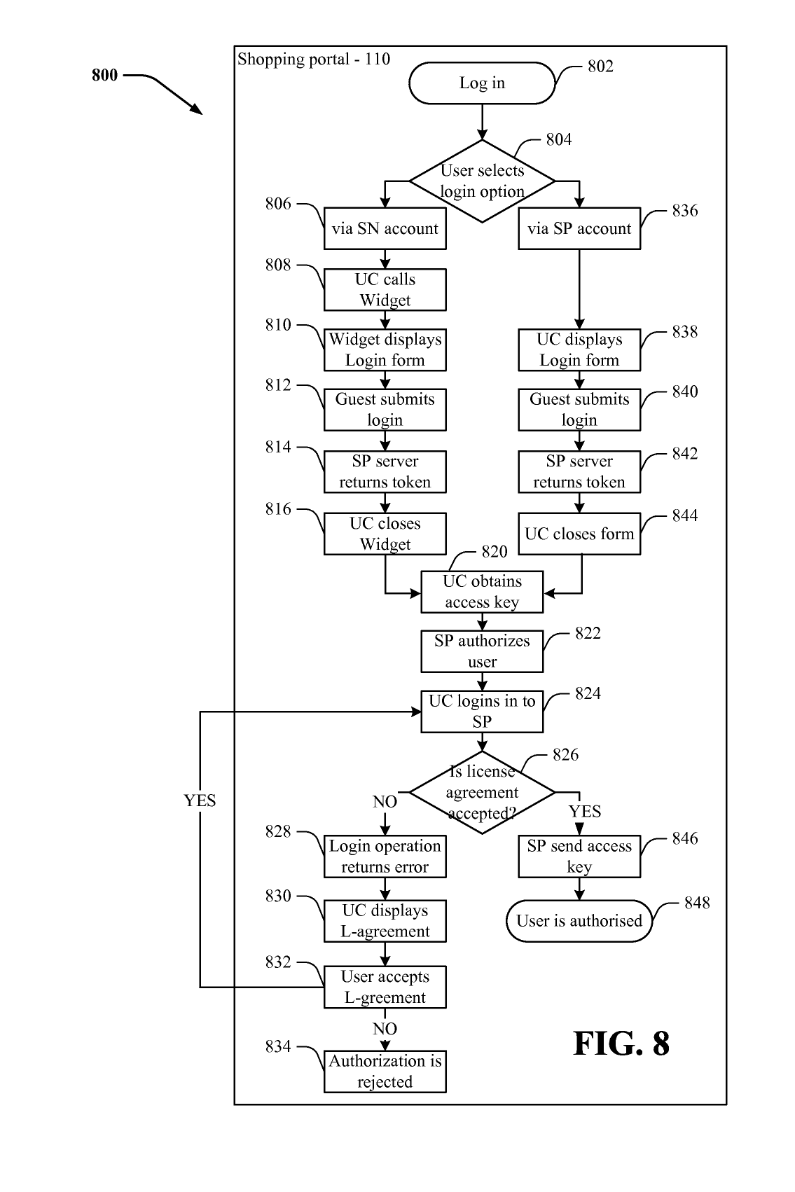

In addition to content data and user preference data, context data can include aggregated user preference data. As used herein, aggregated user preference data includes accumulated personal preference data of all users of the shopping portal 110. For example, in data storage 160, each item can include personal preference data for a specific user as well as data related to the personal preferences of all user's of the shopping portal. In an aspect, aggregated user data includes data for all users, registered and unregistered. In another aspect, aggregated user data includes data for only registered users (discussed infra with respect to FIG. 2). Still, in yet another aspect, aggregated user data includes data for only users of similar interests as determined by the inference component 150. Further, aggregated user data can include data for only “friends” of a user (discussed infra with respect to FIG. 8). In another embodiment, aggregated user data can include all of the categories of aggregated user data discussed above. According to this embodiment, a user can apply a filter component (discussed infra with respect to FIG. 2) in order to select a particular category of aggregated user data.

According to an embodiment, aggregated user preference data includes all personal preference data of aggregated users. For example, aggregated user preference data can include multiple ratings or reviews of the item for each of the aggregated users. In another aspect aggregated user preference data can embody a single rating tallied for an item or a general review of an item determined based on the aggregated user preference data. For example, the intelligence component 150 can evaluate aggregated user preference data and make an intelligent determination as to an appropriate rating or review of an item that takes into consideration each of the aggregated user preferences.

Turning back to FIG. 1, recommendation component is employed to facilitate assisting users in choosing a particular item for purchase. In an aspect, recommendation component 140 is configured to employ a computer to generate a list comprising one or more items from the catalogue 130 that are likely of interest to the user. In order to generate a list, the recommendation component 140 employs one or more algorithms that factor the context data of an item to determine items(s) that are of interest to the user. For example, the recommendation component 140 can scan or search the item catalogue and the related context data for each item. The recommendation component 140 can then generate a recommendation list comprising one or more items that incorporate a user's preference for each item in respect of the content data for each item and aggregated user preferences for each item. According to an aspect, in order to facilitate the searching processes of the recommendation component 140, special files are created and stored for each item based on “snapshots” of the item to provide content index tables for search engines employed by the recommendation component. For example, a snapshot can include the content data, user preference data, and aggregated user preference data for each item.

In an embodiment, the recommendation component 140 can be configured to generate a recommendation list according to a predetermined schedule. For example, the recommendation component can be configured to provide a new recommendation list to a user each day, week, month, etc. In another example, the recommendation component 140 can be configured to generate a recommendation list each time a user logs on to the shopping portal. Still, in yet another example, recommendation component 140 can be configured to generate a new recommendation list each time the context data in the data storage 160 is updated. (See discussion on data update component discussed infra with respect to FIG. 2.)

Referring now to FIG. 2, provided is an item recommendation system 200 according to another embodiment of the subject disclosure. Like item recommendation system 100, item recommendation system 200 includes clients 120, data store 160 and shopping portal 110. In addition to catalogue 130, item recommendation component 140, and inference component 150, shopping portal 110 further includes, filter component 220, authorization component 230, presentation component 240, and data update component 250. In addition, item recommendation system 200 includes one or more external networks 260 in communication with shopping web portal 110.

In addition to receiving a recommendation list from the recommendation component 140, a user can generate an item list from the catalogue 130 or further filter a recommendation list based on one or more user selected criterion. The user selected criterion can include any aspect associated with context data. Filter component 230 enables searching, filtering, and sorting, of items based on a user defined/selected criterion included in the context data. In an aspect, filter component 230 can include a search engine that generates a list of items based on a search criterion input by a user. In an aspect, a user can select any criterion or search term related to context data. For example, a user can input the term “backpacks” and generate a list of backpacks. In another aspect, filter component can include a set of predefined filters or search criterion. For example, a user can select criterion such as most purchased, highest rated, new, favorites, recommended, etc.

Authorization component 230 is configured to facilitate registering a user with shopping portal 110. Once registered, authorization component further facilitates authorizing a registered user. In order to exploit the full functionality of item recommendation system 100 or 200, a user must first register with the shopping portal. In an aspect, in order to receive recommendation lists from recommendation component 140, a user must first register with the shopping portal 110. In another aspect, an unregistered user is provided with limited filter/searching options. For example, in an aspect, an unregistered user or guest can visit the shopping portal 110, search for products based on limited criterion, view items and item categories with limited context data associated therewith, and purchase items. The limited search criterion can include criterion related to only content data. Further, only authorized users are provided with access to the full functionality of social component 220 discussed infra.

In addition, a registered user is provided with allocated personal space within the shopping portal. The personal space can provide a user with a variety features. In one aspect, the personal space can include an area where a user collects and saves references to favorite products from the item catalogue 130 of a shopping portal 110. Such an area is herein referred to as a user's bag 210. Bag 210 is a personal user catalogue where one may temporarily store references to catalogue items and items categories prior to purchasing these items and for providing item references to others so that they may purchase the items as a gift for the user. In an aspect, an authorized user may view his/her bag contentfilter bag content by categories, sort bag content view by data, add items or item categories to his/her bag content, set a rating for item or item category in his/her bag, get item or item category rating in bag by source, set item and item category property (play/pause position, bookmark), sample an item, tag an item, recommend an item, or purchase an item.

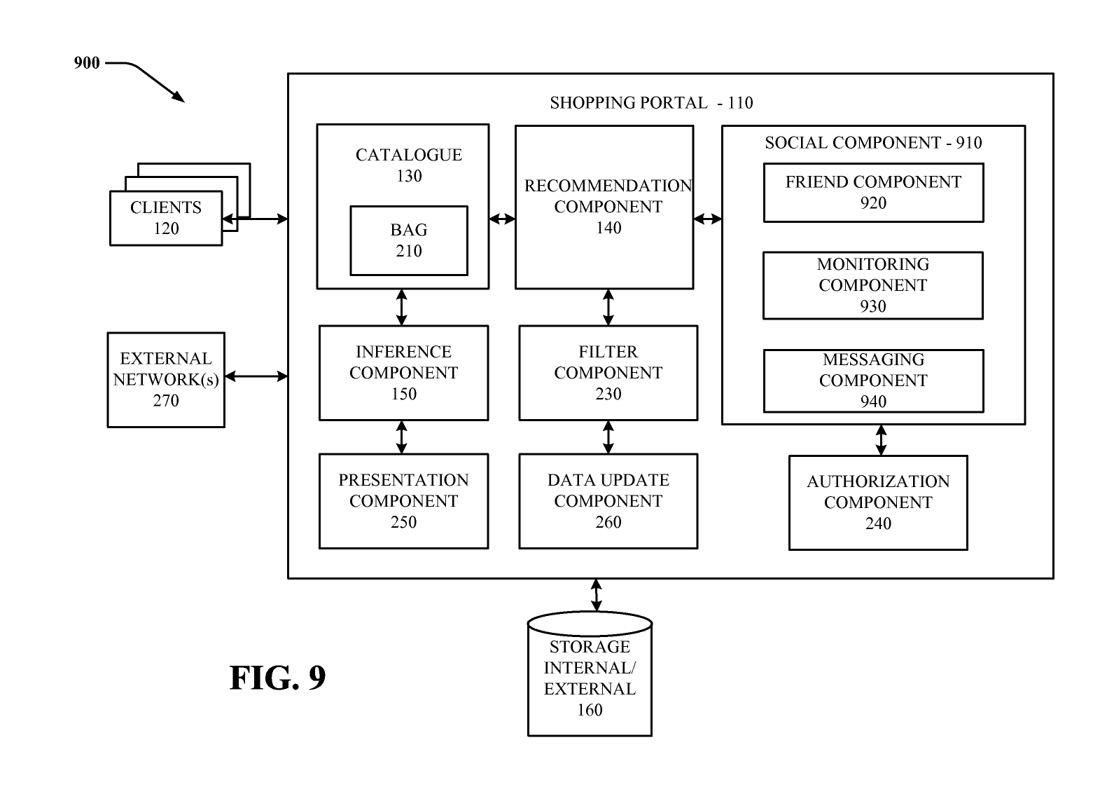

In another aspect, a bag is utilized in a themed social context, where shopping items to be purchased online and related information are shared among users. For example, a user can be authorized to perform the operations above with other user's bags. In one aspect authorization can be provided by associating users as “Friends,” and allowing levels of bag interaction based on authorization levels for “Friends” (discussed infra with respect to FIG. 9). In another aspect, a user can allow his bag to be open to all users, authorized and/or unauthorized. When authorized to interact with others user's bags, a user can then interact with another user's bag in the same manner as his/her own. In addition, a user can purchase an item for another user from their bag. In another aspect, the personal space allocated for a user can provide an area for a user to save and manage item lists.

Various known authorization schemes can be employed to facilitate registering a user with the shopping portal 110. In one aspect, a user can register with the shopping portal by associating himself with a username and password. Identification and authorization information for a registered user can be stored in data storage 160. In another aspect, a registered user can “login” or become authorized to use the functionality of shopping portal 110 as a registered user through an external third party network 260 affiliated with the shopping portal. According to this aspect, integration between each external third party network 260 and shopping portal 110 is completed prior to user login and a user will have an existing account with the selected network 260 prior to login session. In an aspect, third party networks 260 can include product discussion forums, fan sites, product news sites, online product databases, online recommendation and references sites, dictionaries, wikis, user blogs', search engines, decision guides, search engines, social network services, etc. Depending on a network's 260 related functionality, information exchange may be implemented through open authorization protocol, and to allow standard and secure API multi-domain authentication and authorization without exposing the user's credentials.

Referring back to FIG. 2, presentation component 240 is configured to display items, item categories, and item lists with associated context data. For example, in an aspect each item in the item catalogue can include a brief description such as a snapshot of information. By clicking an item name or snapshot, presentation component 240 can present additional information about the item in an item card. In an aspect, the additional information can include content data, user preference data, and aggregated user preference data.

As discussed above with reference to FIG. 1, data storage 160 is configured to store content data, user preference data, and aggregated user preference data for each item or item category of the item catalogue. According to the definitions of content data, personal preference data, and aggregated personal preference data provided above, it should be appreciated that each type of data can change over time. For example, with respect to content data, although aspects of content data remain unchanged such as physical features of an item, other aspects, such as price or promotional offers associated with an item, can change. With respect to personal preference data, a users preferences and tastes, embodied in a user profile or a user social map, can change over time. Further the amount and types of items a user personally supplies preference data for will change over time. As personal user preference data changes, so will aggregated user preference data. Accordingly, context data in the data storage 160 can constantly change.

In view of the dynamic nature of context data, shopping portal can further include a data update component 260. Data update component can be configured to receive new or modified context data, associate the new or modified context data with a particular item or item category and cause the new or modified data to be stored in data storage 160. In an aspect, the new or modified context data can replace old context data. In another aspect, data update component can be configured to remove outdated context data. For example, data update component 260 can cooperate with inference component 150 to determine when context data is outdated. According to this example, the inference component 150 can monitor trends in context data and determine when certain context data becomes an outlier to a new trend or norm. In another example, data update component can be configured to ensure only the most recent context data is associated with an item be remove certain context data after a predetermined time period. For example, aggregated user reviews of a particular service, such as a tax preparation service, can be removed after three years.

Unlike conventional recommendation systems which compare a user profile to some reference characteristics, seek to predict the ‘“rating” that the user would give to an item they had not yet considered, and present an abridged results list to the user based on the prediction, the subject item recommendation systems 100 and 200 associate an item with context data related to the item. In turn the recommendation component employs the context data to generate a recommendation list. Conventional systems employing content based filtering or collaborative filtering do not associate an item with context data in data storage. Further conventional systems do not associate an item with data that incorporates content, user preferences and aggregated user preferences.

With recommendation systems 100 and 200, a user can receive a recommendation list that incorporates item content, user preferences, and aggregated user preferences. Further, a user is able to manually select filters to apply to recommendation lists or to generate other lists specific user. The task of generating a list is efficient because data needed to generate the list is already associated with each item in data storage. In addition, the quality of the list is not compromised by limiting time consuming searchers through thousands or hundreds of thousands user profiles for data. In addition, because systems 100 and 200 associate an item with a variety of context data, where one category of data may be lacking, another category of data can account for the deficiency thus allowing for high quality recommendations. In addition, because the context data can be supplied with no input from the user (via employing the intelligence component), the problem of insufficient data for computer-generated recommendations can be avoided. Furthermore, because context data is dynamically updated, recommendations reflect current user preferences as well as what items are popular for a given point in time. In the context of a system that recommends products to customers, for example, there can be a mechanism for favoring items that are currently “hot sellers.” In addition, a mechanism can be provided that recognizes that the user may be searching for a particular type or category of item. Lastly, each item can be presented to a user with the context data associated therewith. Accordingly, the subject systems 100 and 200 further enable a user to make intelligent manual decisions regarding selection of an item in conjunction with a computer generated recommendation list. The aforementioned advantages merely present a portion of the advantages of systems 100 and 200. It should be appreciated that several additional advantages of systems 100 and 200 may be realized to those skilled in the art.

Referring now to FIG. 3, depicted is an exemplary non-limiting embodiment of asocial graph 300 of interconnected members. The social graph concept is discussed supra.

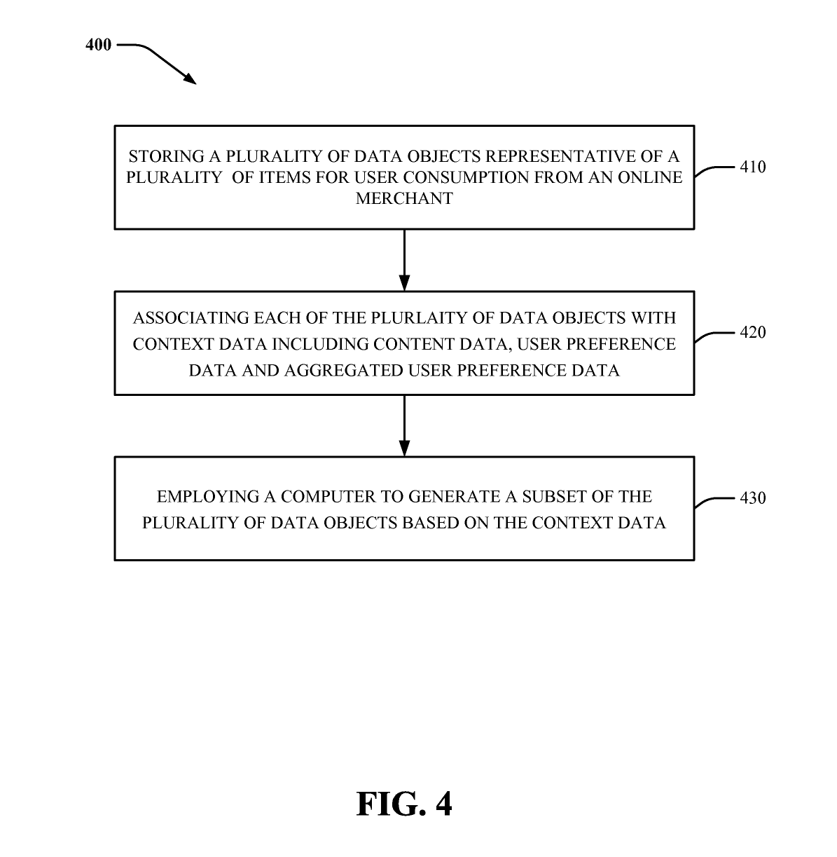

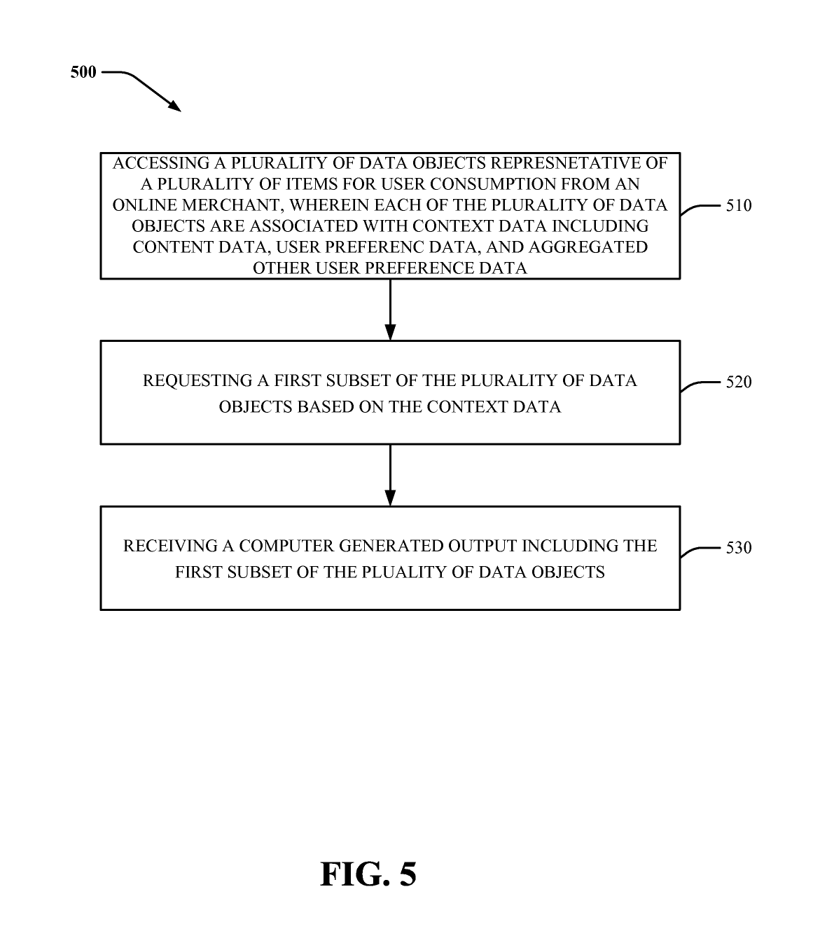

FIGS. 4 and 5 present methodologies in accordance with one or more aspects of item recommendation system 100 and 200. FIG. 4 presents a flow diagram 400 in accordance with generating an item recommendation list in accordance with an embodiment. At 410, a plurality of data objects representative of a plurality of items for user consumption from an online merchant, are stored. At 420, the each of the plurality of data objects is associated with context data, including content data, user preference data, and aggregated user preference data. At 430, a computer generates a subset of the plurality of data objects based on the context data. FIG. 5 presents methodology 500 related to receiving a recommendation list in accordance with an aspect of the subject disclosure. At 510, a user accesses a plurality of data objects representative of a plurality of items for user consumption from an online merchant, wherein each of the plurality of data objects are associated with context data including content data, user preference data, and aggregated other user preference data. At 520, a user requests a first subset of the plurality of data objects based on the context data. For example, in an aspect, by registering with the shopping portal, the user requests to be provided with a recommendation list from the shopping portal. In an aspect, the user can specify how often the desire a new recommendation list to be provided. In another aspect, a user can request a recommendation list by selecting an icon at the shopping portal entitled “recommendation list.” In response to selecting the icon, the recommendation component can generate a recommendation list. Lastly, at 530, the user receives a computer generated output comprising the first subset of the plurality of data objects.

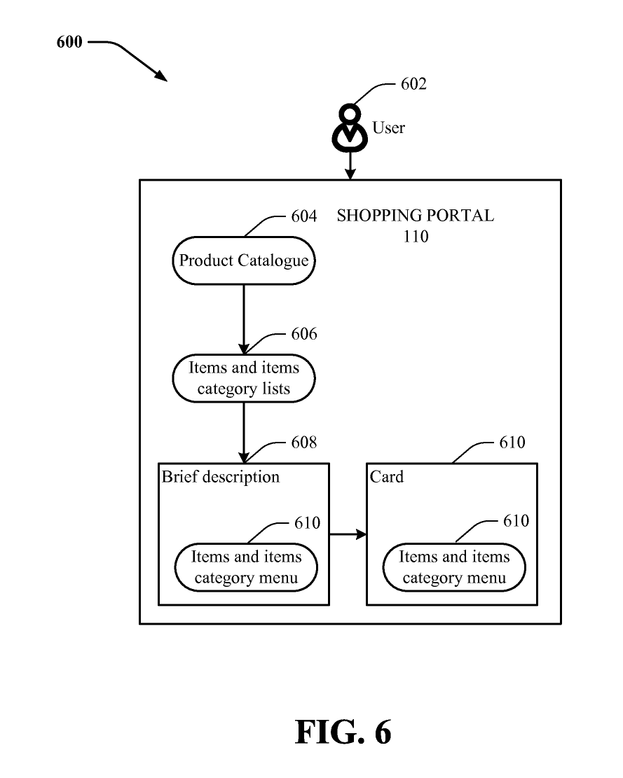

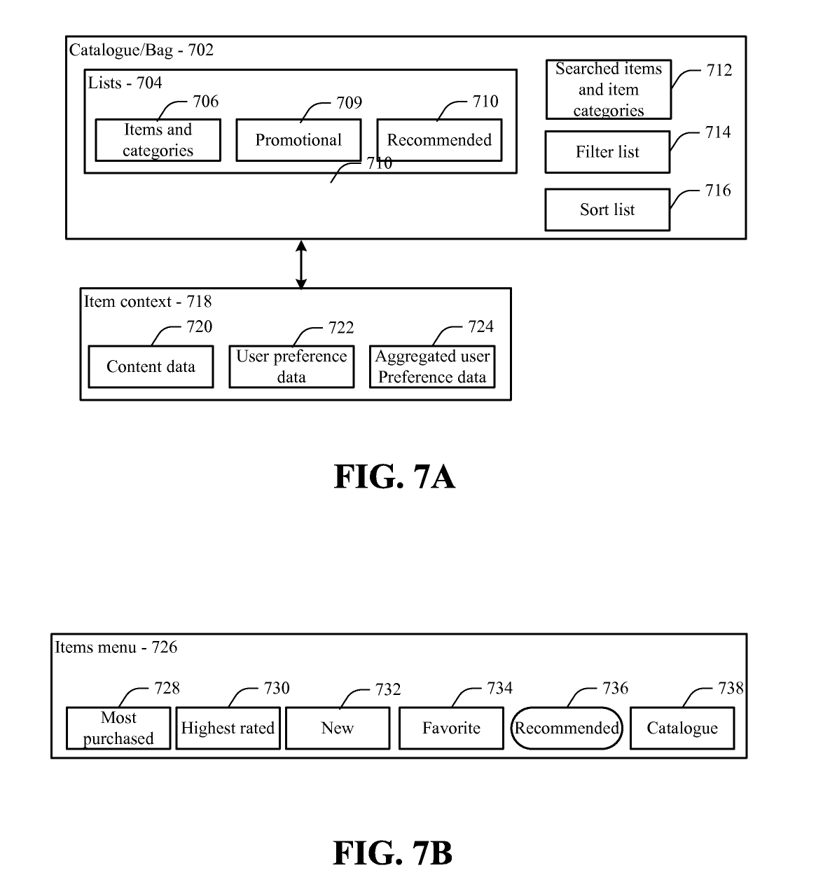

Turning back now to the drawings, FIGS. 6 and 7 illustrates example views of one or more aspects of shopping portal 110 when presented to a user as a webpage. Looking at FIG. 6, presented is basic shopping portal display 600 in accordance with an embodiment. In an aspect, the basic shopping portal display 600 can be presented to all users 602, registered or unregistered. As seen in FIG. 6, shopping portal 110 contains a product catalogue 604 with items lists and item category lists 606. In an aspect, unregistered users can only view the catalogues content list 606 and either an object's descriptions 608 or card 610. By clicking an item name or category name from the item and item category lists 606, a user can be presented with a brief description of the item 608. The brief disruption can further include a link to an item card 610 with additional information about the item. Both brief description 608 and card 610 include limited functionality presented through items and items category menu 610.

FIG. 7A depicts a display of catalogue and bag components 702 according to an aspect of a shopping portal as disclosed herein. As depicted in FIG. 7A, catalogue/bag 702 contains three lists 704. The lists include items and item categories generally 706, promotional items list 709, and recommended items list 710. Items can include goods, services, and offers, and item categories can include categories such as manufacturer name, product types, etc. Each item and item category is associated with collection of context data 718, including content data 720, user preference data 722, and aggregated user preference data 724. In addition, a user is presented with options to search items and item categories 712, filter lists 714, and sort lists.

FIG. 7B present a view of an Items menu 726. In an aspect, an items menu can be associated with a particular type of item category selected. For example, a user could select an item category such as automobiles. Once selected, the user can be presented with items menu 726. Items menu 726 included several links/filter options. In an aspect, the functionality available to a user of the items and items category menu 726 includes links to display a most purchased list 728, a highest rated list 730, a list of new catalogue items 732, a list or users' favorite items 734, and list of recommended items as well as links to return to the full catalogue 732. A user is presented with the same filter options upon navigating to other users bags (discussed infra).

FIG. 8 illustrates a process of user authorization 800 by an item recommendation system in accordance with an embodiment. As noted above with respect to FIG. 2, authorization component 230 is configured to facilitate registering a user with shopping portal 110. Once registered, authorization component further facilitates authorizing a registered user. A variety of authorization methods are contemplated within the spirit of the subject disclosure. For example, authorization schemes can include, but are not so limited to, a login procedure wherein a user can login to the shopping portal directly by supplying a user name and password. In another aspect, a user can login to an affiliated network which in turn establishes authorization with the shopping portal 110. In an aspect, the login procedures can employ a token based scheme. Still in yet another aspect, authorization can be accomplished without a login process. For example, a user device can be automatically recognized and authorized by the shopping portal via an inherent characteristic of the device, such as a user ID associated with the device, a phone number, or a subscriber identity module (SIM) card.

For simplicity, FIG. 8 presents an authorization method involving a login procedure. With respect to FIG. 8 now, in order to begin the authorization process 800, a user navigates to shopping portal 110 and selects to login link 802. A user client device (UC) presents the login options 804 including: via and affiliated social network (SN) account 806 or via a shopping portal (SP) account 836. If user selects to login via the affiliated SN account 806, UC facilitates a redirect to the SN account. It should be appreciated that any type of software and associated protocol capable of handling a redirect can be employed by the UC. Client side scripts can include but are not limited to, JavaScript™, Visual Basic Scripting (VBScript) by Microsoft, Extensible User-Interface Language (XUL) by the Mozilla project, Extensible Stylesheet Language Transformations (XSLT), and asynchronous JavaScript™ and XML (AJAX). Server side scripts can include for example, Perl, Hypertext Preprocessor (PHP), Active Server Pages (ASP.NET), JAVA™, and server-side VBScript. In addition, the communication protocol can include Transmission Control Protocol (TCP), User Datagram Protocol (UDP), Internet Control Message Protocol (ICMP), Hypertext Transfer Protocol (HTTP), Post Office Protocol (POP3), File Transfer Protocol (FTP), Internet Message Access Protocol (IMAP).

Turning back to FIG. 8, at 806, the UC opens a JavaScript™ enabled WebView widget capable of handling redirects 808 via HTTPS from affiliated SN URL The widget displays the login form, provided by the affiliated SN 810. At 812, a user/guest enters the SN and submits his/her login name and password. The SP server intercepts a SN token, authenticates the user and returns redirect with temporary authentication token to the UC 814. Next, the UC receives redirect, extracts the temporary authentication token and closes the widget 816. At 820, the UC has the SP session token and access key to access required information. Then at 822, the user/guest is recognized as authorized SP service member.

Alternatively, if user selects to login via a SP account 836, UC displays the SP login form 838. The user/guest enters and submits SP login name and password at 840. Then at 842, the SP server sends back redirect with temporary authentication token and at 844 the UC closes the login form. Now, at 820 the UC has the SP session token and access key to access required information. At 822, the user/guest is recognized as an authorized SP service member.

Once a user is authorized as a service member, at 824 the UC attempts to log in to SP with a temporary authentication token and device ID as parameters. At 826 the system validates if the user has confirmed the SP license agreement already. If not, the login operation returns an application-level error code 828. In an aspect, wherein internet protocol (IP) is employed to facilitate communication, the login operation can also return a URL of the text of the licensing agreement. The UC then displays the license agreement to the user 830. If the user accepts the license agreement at 832, the UC attempts to log again to SP with temporary authentication token and device ID as parameters at step 826. When the license agreement is accepted, the SP server sends back a response with session token and access key 846. The user then enters the SP as authorized 848. If user rejects license agreement, the authorization is declined at 834 and a corresponding dialogue box is displayed to the user.

Referring now to FIG. 9, presented is an item recommendation system 900 in accordance with another embodiment of the subject disclosure. Item recommendation system 900 can include all of the components of item recommendation system 200. In addition, shopping portal 110 can further include social component 910. It should be appreciated that although item recommendation system 900 is presented with several components, item recommendation system can include a portion of the components presented. For example, in an aspect, item recommendation system 900 can include shopping portal 110 that includes a catalogue 130, a recommendation component 140, an inference component 150, and a social component 910 where the shopping portal 110 is further coupled to data storage 160 and one or more clients or users 120.

Social component 910 is configured to facilitate assist a user in determining items which the user may desire to purchase based on input from other users who are selected by the user to be “friends” of the user. Friends can include other users registered with the shopping portal and selected by the user who in response to selection, authorize the online relationship. Unlike traditional collaborative filtering techniques in which the individual whose input relied upon for making general inference about a user's likely affinity for an item is determined by a computer, the social component 910 enables a user to select the individuals whose opinions are relied upon in making determination with regards to item selection. In an aspect, the social component 910 enables a user to personally select whose online activities related to catalogue items shall be applied in computer-implemented calculation of recommended items for the active user.

Social component includes friend component 920 configured to facilitate generating friends of a user. In an aspect only users registered with shopping portal 110 can become shopping portal friends within the context of the subject disclosure. Each registered user can have a list of one or more shopping portal friends. The list of friends can be maintained by friend component 920 and stored in data store 160. In another aspect, the friends list can be associated with an external social network and maintained at the external social network.

The friend component 920 can further be configured to enable a user to manage a user's friends list, enable user manipulation of his or her friends list, and facilitate interaction between friends. In an aspect, once users become friends, friend component 920 can allow a user to view his or her friends list, request friendships, revoke friendships, and limit friend's access to information about the user. In another aspect a user can view the social activity of each friend (discussed infra). In another aspect, a user can view a friend's bag 210, and interact with the items in the friend's bag. For example, a user can view items in a friend's bag, purchase the item for himself/herself, purchase the item for the friend, rate the item, review the item, tag the item, sample the item, or add the item to the user's bag.

Friend component 920 can facilitate a user in generating a list of friends in a variety of ways. In one aspect, friend component 920 can include a friend search engine that allows a user to search for individual that he or she might know by name, or some other identifying criterion. If the searched individual is in fact registered with the shopping portal, then the user can be provided with a link to request a friendship between the user and the searched individual. Upon acceptance of the friendship, the searched individual becomes can become a friend of the user and added to the user's friends list. In another aspect, a user can invite individual participating in external networking sites to join the shopping portal 110. Once the individuals join the shopping portal, the user can request a friendship. In another aspect, a user can import a list of individuals from an external social network who may or may not be registered with shopping portal 110. For those individuals whom are registered with the shopping portal 110 the friend component 920 can facilitate authorizing a friendship. For those individual whom are not registered with the shopping portal 110, the friend component can facilitate inviting those non-registered friends to become registered.

Still in yet another aspect, friend component 920 can communicate with inference component 150 in order to automatically generate a list of individuals whom the user may desire to be friends with. For example, inference component 150 can compare preference data of users and identify similarities in preference data. The friend component 920 can in turn provide the user with a list of the individuals identified having similarities to the user. In response, the user can choose whether or not to request a friendship between any of the individuals on the list. In another aspect, the friend component 920 can automatically send out friend requests on behalf of the user based on the identified individuals thus automatically populating a user's friend list.

Social component 910 enables item recommendations based on social data. Social data includes data related to a friend's interaction with an item. For example social activities and the data associated therewith can include when: an item is purchased by a user friend; an item is rated by a user friend; an item is favored by a user friend, or an item is reviewed by a user friend, though by no means is the foregoing list inclusive or exhaustive as many other activities are considered social. In another example, social activities of an online video on-demand shopping portal may include the number of friends who rented this item, the number of friends who purchased this item, the number of friends who watched an item, the number of friends who reviewed an item and the particular reviews for each friend, the number of friends who rated an item and the particular ratings for each friend, the number of friends who marked the item as wanted, number of friends who bookmarked the item, the number of friends who recommended (shared) the item, and the number of published video clips of the item. It should be appreciated that the several of the social activities provided with respect to video-on-demand items can be applied to other items. Because the social data for an item accounts for not only what other seem to like or dislike with respect to an item but what a users friends seem to like or dislike, a user can be further assured that an item recommendation based on social data stems from trusted sources. Further, because a user can have an unlimited number of friends, the amount of social activity with respect to an item is likely to reflect current market trends for items relevant to a user.

In order to collect social activity data, the social component can employ monitoring component 930. Monitoring component 930 is configured to monitor the social activity of a user. In an aspect, monitoring component is configured to store all social activity data of the social activity of a user in data storage 160. The social activity data can further be associated with an item in particular and stored in data storage 160. For example, in addition to context data, each item can be associated with social activity data. According to the subject embodiment, recommendation component 140 is configured to employ the collected social activity data and output a computer generated recommendation list based on at least the social activity data. In an aspect, a particular item can have a social weight based upon the sum of social activities with an item where each type of activity can be given a different weight value. The social weight value of an item can be provided to a user or employed by the recommendation component in order to generate an item recommendation list of one or more items. For example, items with high social weight values can be included in a recommendation list.

In another aspect, the friend component 920 can allow a user to manage social activity data monitoring and collection for a user. For example, the friend component can further be configured to allow a user to set a certain level of his/her social interactions with other users. For instance a user may set rules for who is allowed to follow his/her social activities, the degree of social activities the user desires to be monitored for each friend, what and where notification of activities are to be published, whether user status is searchable or hidden, and etc. The social activity monitoring/collecting rules can be stored in data storage 160 a user preference data.

In another aspect, recommendation lists based on social activity data can be filtered. For example, a user can employ filter component 230 in order to select criterion to filter the social activity recommendation list or to generate a different list based on user selected criterion. With respect to this embodiment, a user can select criterion based on context data as well as social activity data. For example a user can select context criterion to filter the social activity based recommendation list including content based criterion such as an items physical attributes or price, personal preference data such as the type of items the user particularly likes, and/or aggregated user data such embodying the affinities of all registered users for an item. In addition, a user can filter a social activities recommendation list by a social activity type or a particular set of friends. For example recommendation list items list can be filtered is by recommendation type and further sorted in reverse chronological order of date sent for friend submissions, in reverse order of recommendation weight for social recommendations and in reverse order of recommendation weights for service recommendations.

In addition, social recommendation component 910 can provide for directed recommendations from friends. In particular, social recommendation component 910 can include a messaging component 940. Messaging component enables a user to send messages to friends recommending an item. According to an aspect, when a user selects a product from the catalogue 130 or user bag 210, a user can be provided with several prompts. In an aspect, these prompts can include an offering to rate an item, an offering to review an item, and/or an offering to send a recommendation message to friend. The recommendation message can include a personal message regarding the item, a rating, or a review. In an aspect, the recommendation can be in the form of an email targeted to a friend. In another aspect, the recommendation message can be in the form of message that is posted to a public viewing area of a friend's related social network. Still in yet another aspect, the recommendation message can be in the form of an instant message.

Because recommendation system 300 can include each of the components of recommendation systems 100 and 200, recommendation system 300 can provide each of the advantages of recommendation 100 and 200 discussed above. In addition, unlike conventional recommendation systems, recommendation system 300 employs social activity data to generate recommendations. Unlike collaborative filtering computer models for product recommendation, with system 300, a user selects whose online activities related to catalogue items shall be applied in computer-implemented calculation of recommended items for the active user. Because a user selects whose impressions should be applied to computer-implemented calculation of recommended items, the user can better trust that the recommendations reflect the user's interests. In addition, with system 300, a user can get a list of recommended items directly from friends. Further, a user can manage the type of data received regarding a friends social activities to further tailor recommendations. Because social activity data can be associated with an item and stored, item lists based on social activity data can be efficiently generated and filtered based on one or more social activities.

Furthermore, unlike basing recommendation on how other rate an item, basing a recommendation on an item's social weight reflects what is currently “hot” or popular, and embodies richer data than a mere rating number. This is because social activity data accounts for a variety of user interaction with an item and not merely rating an item. The fact that social activity data is dynamically generated and updated further causes a recommendation based on social activity data to reflect current trends for items. Furthermore, recommendations based on social activity reflect short term browsing or current tastes of a user. The aforementioned advantages merely present a portion of the advantages of system 300. It should be appreciated that several additional advantages of system 300 may be realized to those skilled in the art.

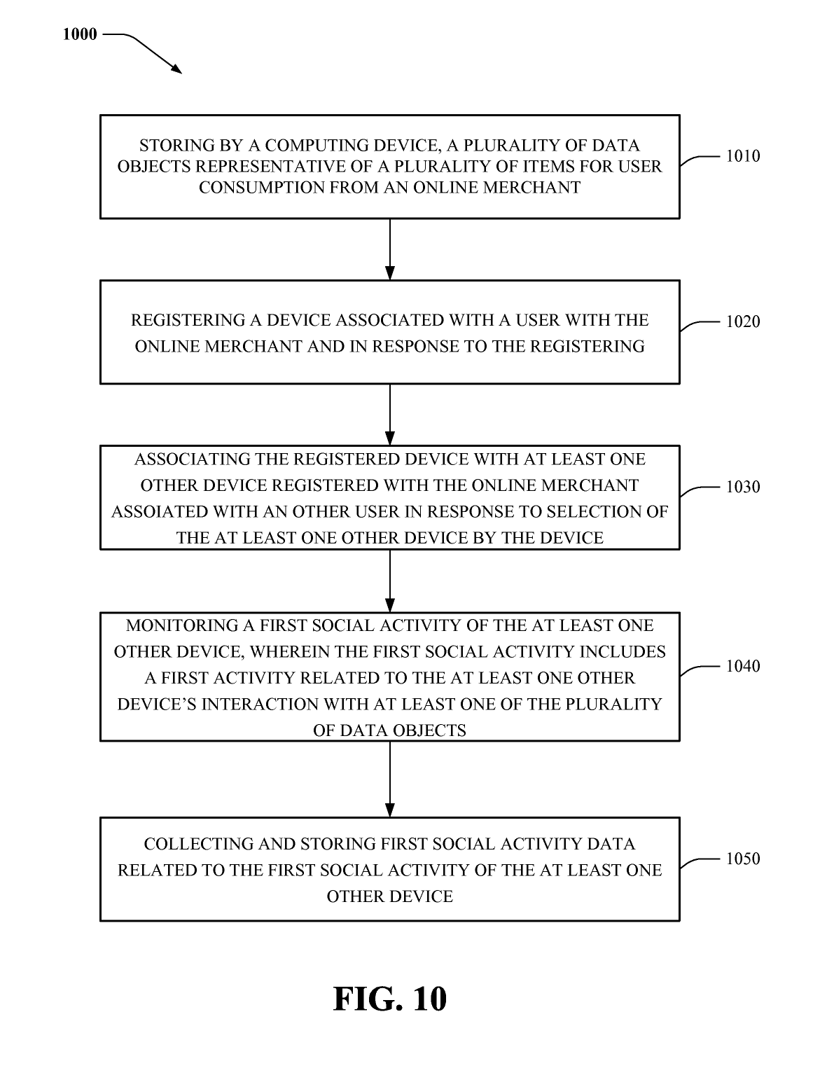

Turning back to the drawings, FIGS. 10, 11, and 12 depict methodologies in accordance with one or more aspects of item recommendation system 900. FIG. 10 presents a flow diagram 1000 in accordance with generating an item recommendation list in accordance with an embodiment. At 1010, a plurality of data objects representative of a plurality of items for user consumption from an online merchant, are stored. At 1020, a device associated with a user is registered with an online merchant. In response to registering, at 1030, the registered device is associated with at least one other device registered with the online merchant associated with an other user in response to selection of the at least one other device by the device. For example, a device can become associated with another user in response to a user selecting one or more friends. At 1040, a first social activity of the at least one other device is monitored, wherein the first social activity includes a first activity related to the at least one other device's interaction with the at least one of the plurality of data objects. In other words, the social activity data of a friend is monitored such as when friend views an item, purchases an item, favors an item, reviews and item, rates an item, tags an item, recommends an item, or disfavors an item, etc. Then at 1050 the first social activity data related to the first social activity of the at least one other device, is stored.

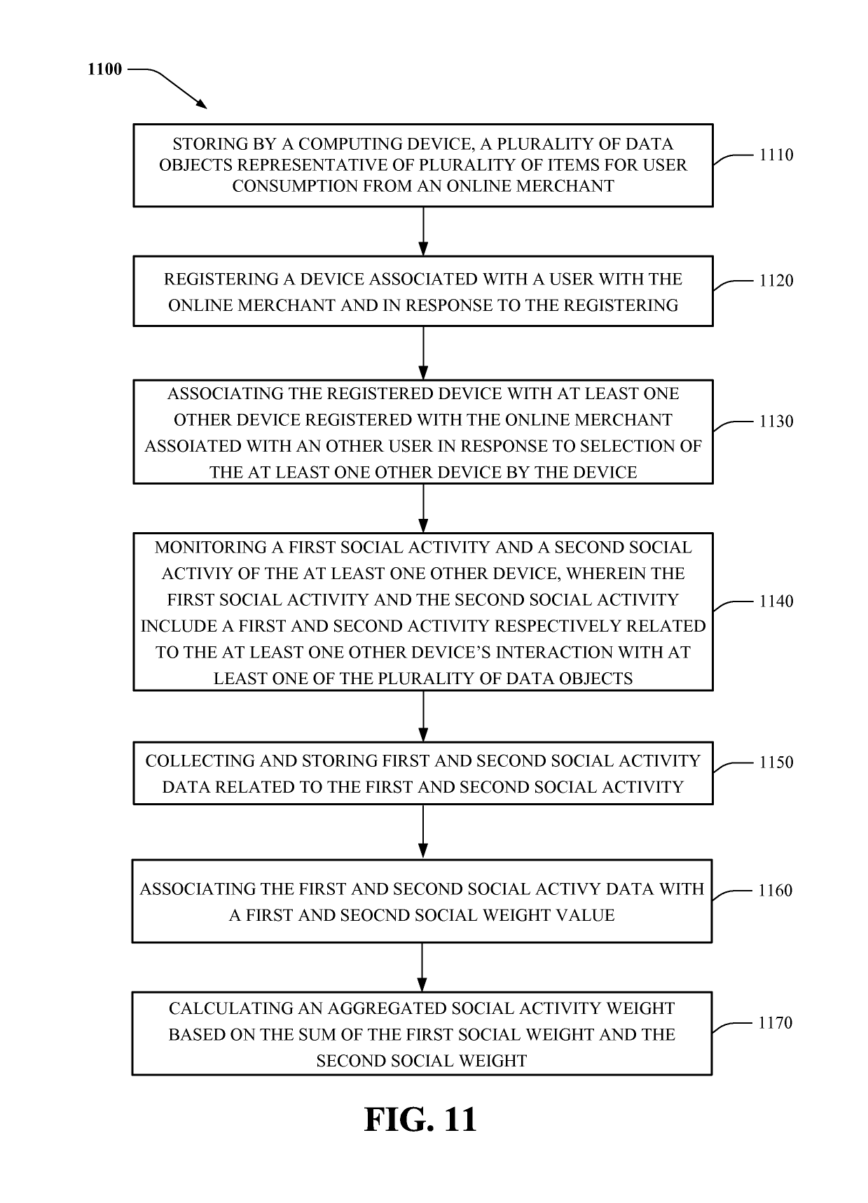

FIG. 11 presents a flow diagram 1100 in accordance with generating an item recommendation list in accordance with another embodiment. Steps 1110-1130 are the same as steps 1010-1030. At step 1140, a first social activity and a second social activity of the at least one other device is monitored, wherein the fires social activity and the second social activity include a first and second activity respectively, related to the at least one other device's interaction with at least one of the plurality of data objects. At 1150, first and second social activity data related to the first and second social activity is collected and stored. At 1160, the first and second social activity data is associated with a first and second social weight value respectively. Lastly, at 1170, an aggregated social activity weight is calculated based on the sum of the first social weight and the second social weight.

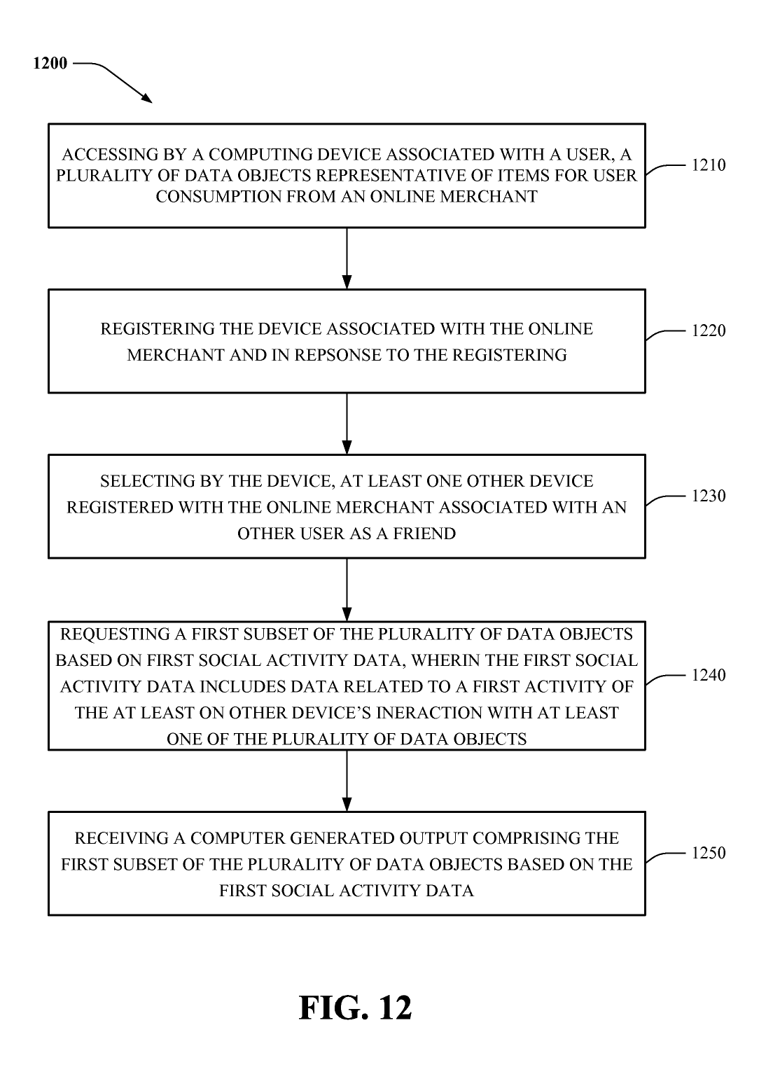

FIG. 12 presents a flow diagram 1200 in accordance with receiving an item recommendation list in accordance with an embodiment. At 1210, a device associated with a user accesses a plurality of data objects representative of items for user consumption from an online merchant. At 1220, the device is registered with the online merchant. At 1230, the device select at least one other device registered with the online merchant associated with an other user as a friend. At 1240, the device requests a first subset of the plurality of data objects based on first social activity data, wherein the first social activity data includes data related to a first social activity of the at least one other device's interaction with at least one of the plurality of data objects. Then at 1250, the device receives a computer generated output comprising the first subset of the plurality of data objects based on the first social activity data.

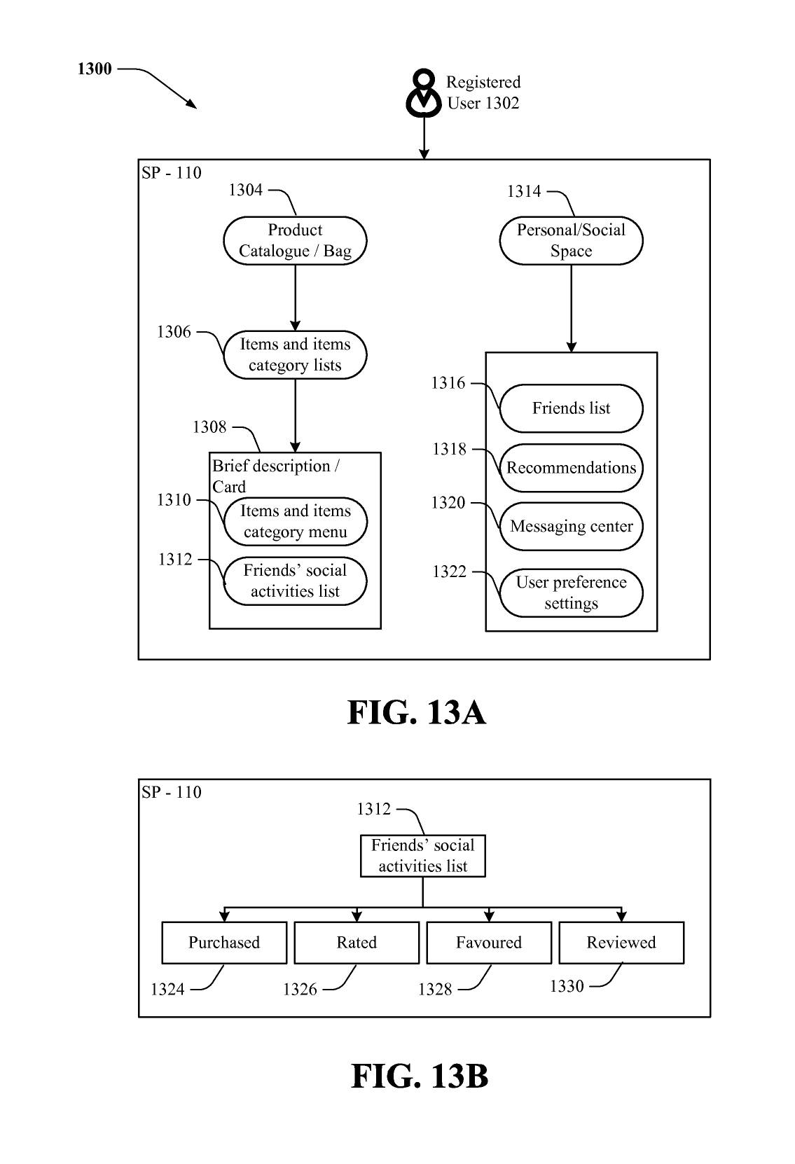

FIG. 13A presents an example view of one or more aspects of shopping portal 110 when presented to a user as a webpage. Looking at FIG. 13A, presented is shopping portal display 1300 in accordance with an embodiment. In an aspect, shopping portal view 1300 is only presented to registered users 1302. A logged in user 1302 can view product the catalogue or their bag 1304. As discussed above, a bag is a personal user catalogue where one may temporarily store references to catalogue items and items categories prior to purchasing these items and for providing item references to others so that they may purchase the items as a gift for the user. Bag items and categories viewing and management is similar to that of the general catalogue. The catalogue/bag can contain items and item category lists 1306. Each item or item category can further include a brief description or item card 1308. In an aspect, user 1302 can be presented with brief description/item card in response to clicking an item name or snapshot of the item. Both brief description and/or card 1308 can include a complete set of functionality presented through items and items category menu 1310 and the list of user friends' social activities 1312.

Further, shopping portal 110 can provide a registered user with personal/social space 1314, where he/she may socialize with friends. The personal/social space 1314 is aimed to assist users with finding new items for purchase that most likely is of interest to the seekers. In an aspect, the personal/social space contains a users' friends list 1316, a list of recommended items and items categories 1318, a messaging center 1320 and user preference settings 1322.

Logged in user is provided with a variety of shopping portal features. In one or more embodiments, a logged in user 1302 may view his/her bag content or that of his/her friends, who authorized such access, filter bag content by categories, sort bag content view by data, add an item or item category to his/her bag content, view comments in his/her personal/social space, write comments in his/her social space, set a rating for item or item category in his/her bag or a friends bag, get item or item category rating in a bag by source (e.g., a friend name's, name of search engine search results, external product website find, etc.), set item and item category property (play/pause position, bookmark), send private messages or recommend an item or item category, view an allocated inbox folder with private messages, or purchase an item.

FIG. 13B presents a view of a friend's social activity component in accordance with an embodiment. In an aspect, various lists, such as item and categories lists, friends lists or guest lists, can include a link to the friends social activities list 1312. In the context of shopping portal 110, a friend's social activities can include: when an item is purchased by a friend 1324; when an item is rated by a friend 1326; when an item is favored by a friend 1328, and when an item is reviewed by a friend 1330. The shopping portal 110 can include a promotional information in place of friends social activities information where items do not have recent friend's social activities data pertaining thereto or for users who do not have friends and for unauthorized users.

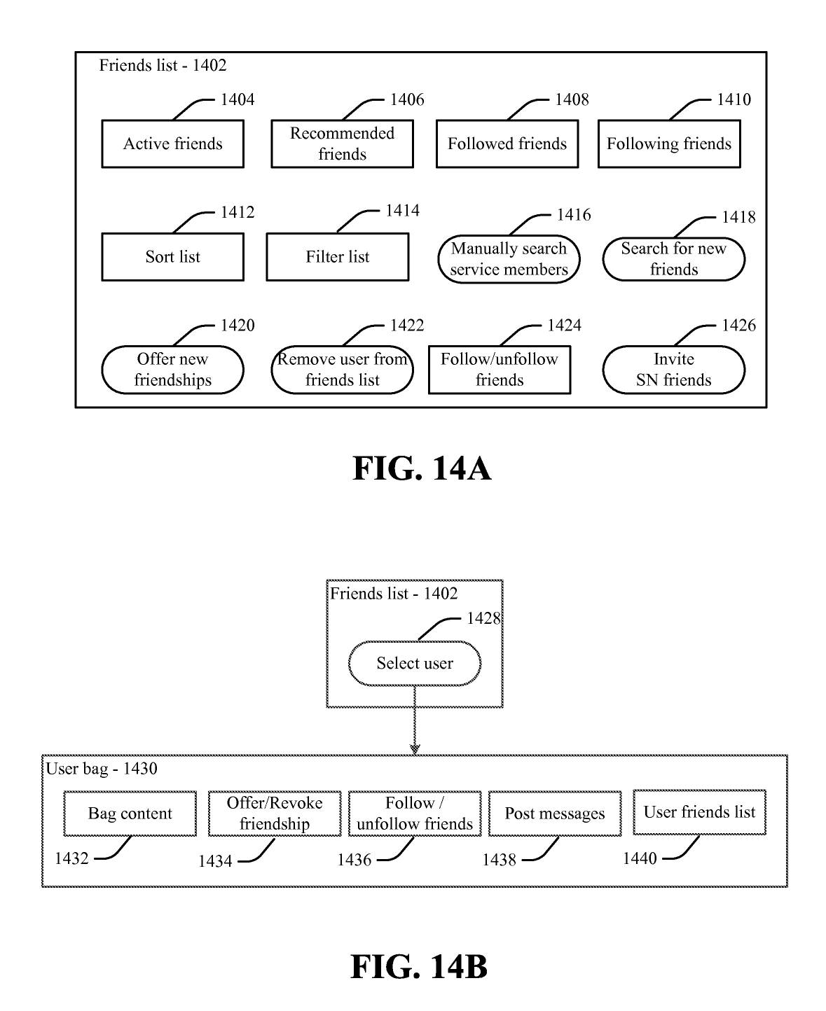

Looking at FIG. 14A depicted is a view of a user's friend's list components. In friends list 1402, a logged in user may manage their list of friends through a variety of components. Friends list 1402 includes a list of active friends 1404, a list of service members the user may like and know determined by a recommendation engine based on given parameters 1406, a list of user's followed friends 1408, and list of user's following friends 1410. In one aspect, a followed friend is a specific friend selected by the user whom the user desired to receive notification of all social activities of that friend. Service members' lists may be sorted 1412 and filtered 1414. Further, a user can manually search for service members 1416, or search for new friends 1418. In addition, friends list 1402 can include components that facilitate offering new online friendships to other service members and non-service members 1420, removing service members from friends list 1422, following/unfollowing friends 1424, and inviting SN user friends to join SP 1426.

Turning now to FIG. 14B, presented is a flow diagram for navigating in another user's bag 1430. In addition to accessing a user bag, other user's bags may be accessed several ways. For example, a user may navigate to his/her friends list and select a friend name, friend avatar, or select a social activity name from a list presented in brief description or in item or category cards. As seen in FIG. 14, by selecting a service member 1428 in the friends list 1402, the system displays selected user bag 1430. Here, a user may view selected service member bag content 1432, offer new online friendship or revoke friendship 1434 depending on current friendship status, select to follow or unfollow a friend 1436, post personal messages 1438, and view a list of another user's friends.

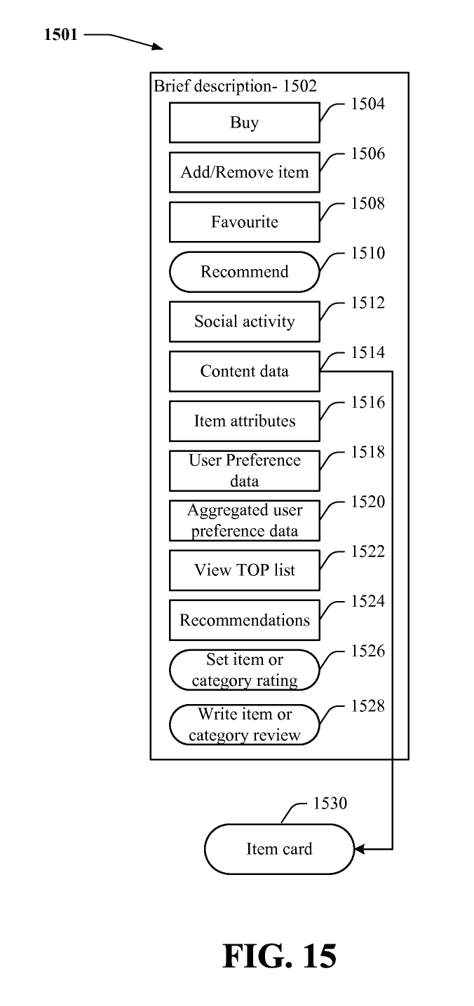

Presented in FIG. 15 are various components of a brief item description 1502 in accordance with an embodiment. As depicted in FIG. 15, a user may purchase an item by clicking buy link 1504 in brief description 1502 or item card 1530 without logging or registering in the system. Although all other links shall be displayed to a guest user, in order to complete requested operation, the system shall request user registration or logging in. Other options available in the brief description 1502 are as follows: depending on the item/category current status, Add item to or Remove item from the user Bag 1506; mark item as favorite 1508, recommend item to user friend(s) 1510, view social activities related to the item 1512; view item's content data 1514, view item attributes 1517, view item user preference data 1518, view item aggregated user preference 1520, view list of TOP items in selected category type 1522, view list of recommended items 1524. In an aspect, by clicking item title or snapshot in the item content data 1514, user opens item card 1530

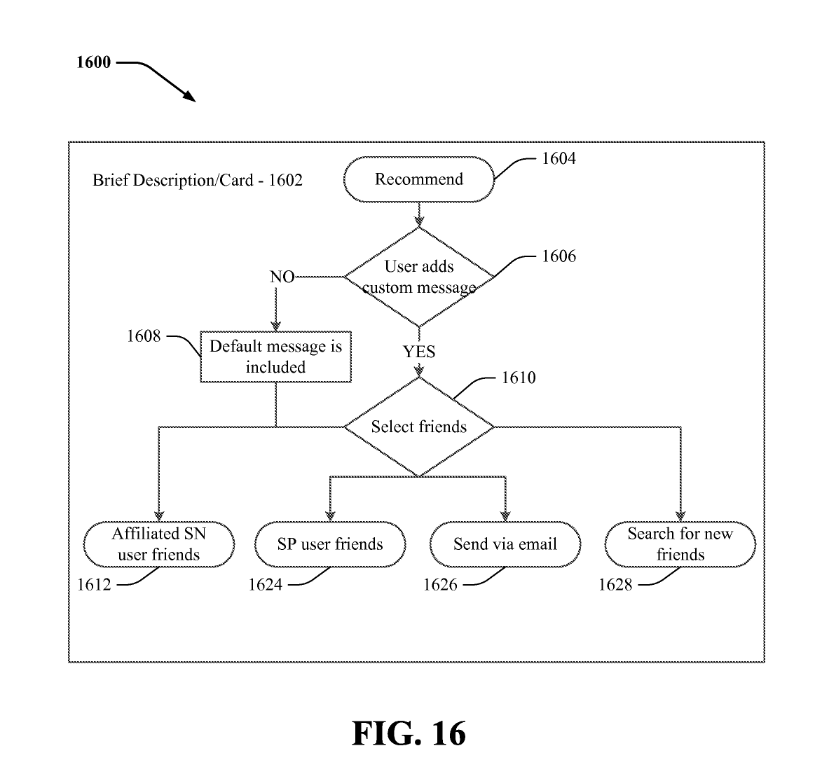

FIG. 16 presents a flow diagram for recommending an item 1600. At 1604, a logged in user may select to recommend an item from brief description or item card 1602. At 1606 a user may add custom text message for a recipient. If user does not include the text, default recommendation message shall be provided 1608. Next, at 1610, a user selects friends as recipients. Friends can be selected from displayed friends' lists of affiliated SN user friends 1612, or SP user friends 1624. In another aspect, friends can be selected by searching for new friends 1628. After friends are selected message is sent to the respective friend at a mailbox associated with the affiliated SN for the friend, or at a mailbox affiliated with SP for the friend. In another aspect the message can be sent to new friends searched for and or to any persons via an email address 1626.

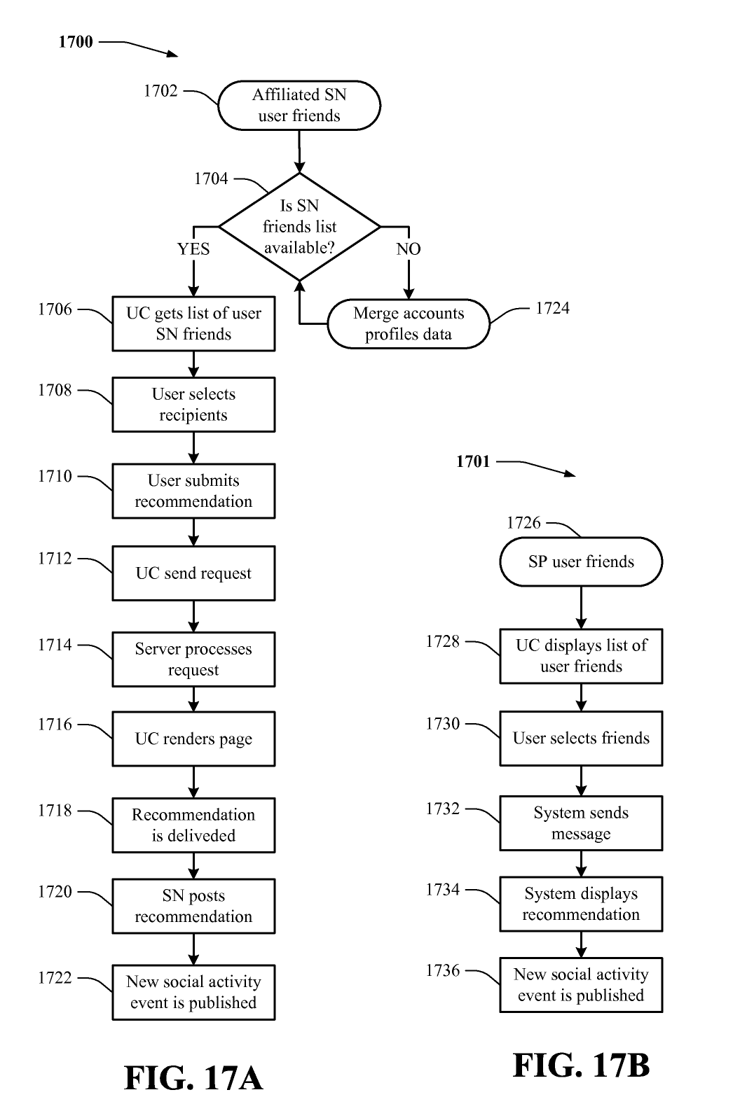

FIG. 17A presents a flow diagram 1700 for selecting a friend affiliated with a social network 1702 as a recipient of a recommendation. At 1704, if the user's SN friends list is available to SP, UC gets list of affiliated SN friends stored at the SP database 1706. A user then selects intended recipients and submits a recommendation 1710. At 1712, the UC creates and sends the request to the SP server with item ID, friend(s) ID's list and the message. At 1714 the SP server processes the request. At 1716 the UC renders a page with recommendation sent status if the recommendation is in fact sent. At 1718, the recommendation and the message are delivered to the recipient(s). Depending on SN functionality, the recommendation title and related message shall be published to a viewing space of the user friend's SN 1110. Recipients have new activity event with information about recommendation 1112. Returning back to step 1704, if the affiliate SN friends list is not available to the SP or if the SN returns invalid SN access token, then the UC initiates process of accounts data merger and imports list of user SN friends 1724 and repeats procedure 1700.

FIG. 17B presents a flow diagram 1701 for selecting a friend who is a member registered with the shopping portal, (an SP user friend 1726), as a recipient of a recommendation in accordance with an embodiment. At 1728, a UC displays the list of user friends. The user then selects the recommendation recipients from the list 1730. At 1732, the system delivers recommendation and the message to the recipient(s). At 1734, the system displays the recommended item in the recommended items and in a notification inbox list. Then at 1736, the social activity event is published to the recipient user with information about the recommendation.

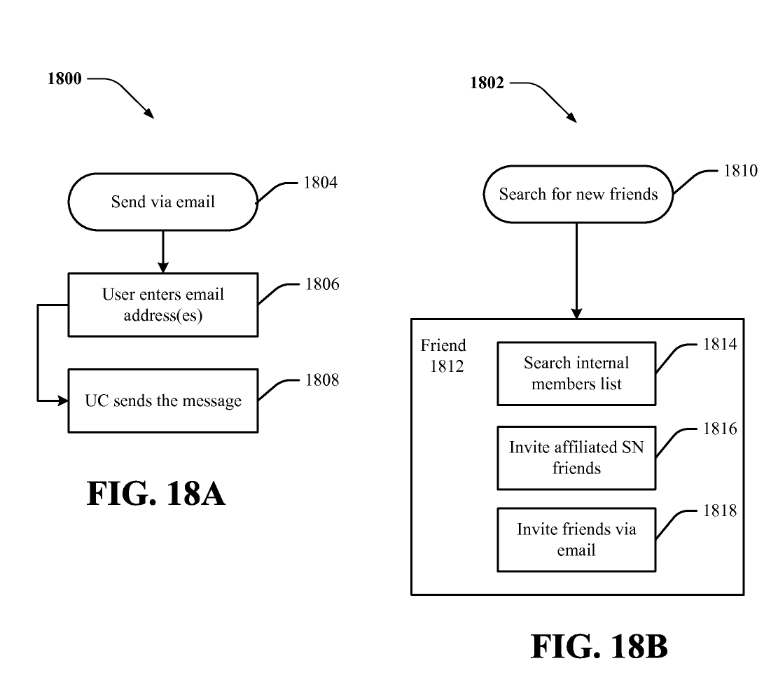

FIG. 18A presents a flow diagram 1800 for sending a recommendation to a recipient via an email. At 1804, a user selects to send a recommendation via email. At 1806, the user then enters recipient's address or selects recipients from a contacts list. Then at 1808, the UC uses platform-specific contacts/mMail application to send the message.

FIG. 18B presents a diagram 1801 of view of a shopping portal that facilitates a user when searching for new friends. At 1810, a user can select a link for a searching component entitled “search for new friends” 1810. In response, friend component 1812 can present the user with three searching options including: search internal members list 1814, invite affiliated SN friends, and invite friends via email 1818.

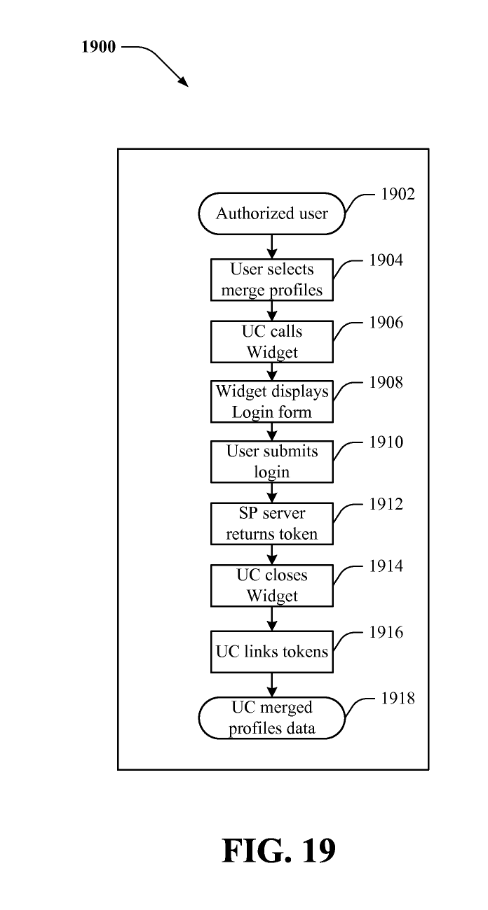

FIG. 19 presents a flow diagram 1900 illustrating the process of linking a registered user's 1902 affiliated SN account profile data to that of his/her SP account. Linking accounts profiles allows users to import and export user profile data and friends lists into/from his/her SP account, and to have an option of posting events notifications of the user social activities at the affiliated SN account. Once a registered user's SN account is linked to their SP account, authorization to both the SN and the SP is shared. A variety of authorization schemes can be employed to facilitate linking a user's SN account and SP account. For example, as discussed above with respect to FIG. 8, authorization schemes can include, but are not so limited to, a login procedure employing a token based scheme or an automatic procedure wherein a user device is recognized and authorized by the shopping portal via an inherent characteristic of the device, such as a user ID associated with the device, a phone number, or a subscriber identity module (SIM) card. FIG. 19 presents an example wherein linking is accomplished with a token based login authorization scheme.

At 1904, a user logged in with his/her SP account selects merge affiliated SN profile link. In order to facilitate merging, it should be appreciated that any type of software and associated protocol capable of handling merging can be employed by the UC. For example, client side scripts can include but are not limited to, JavaScript™, VBScript, XUL, XSLT, and AJAX. Server side scripts can include for example, Perl, PHP, ASP.NET, JAVA™, and server-side VBScript. In addition, the communication protocol can include Transmission Control Protocol (TCP), User Datagram Protocol (UDP), Internet Control Message Protocol (ICMP), Hypertext Transfer Protocol (HTTP), Post Office Protocol (POP3), File Transfer Protocol (FTP), Internet Message Access Protocol (IMAP).

At 1906 the UC opens the JavaScript enabled WebView widget capable of handling redirects via HTTPS from affiliated SN URL. At 1908 the widget displays the login form, provided by affiliated SN. Then at 1910, the user enters the SN and submits login name and password. At 1912, the server intercepts the SN token, authenticates the user and returns redirect with temporary authentication token to the UC. A 1914 the UC receives redirect, extracts the temporary authentication token and closes the widget. At 1916 the UC links temporary authentication token to the existing SP token. Lastly, at 1918, the SP server merges SN user data to existing SP profile and sends back the merging result.

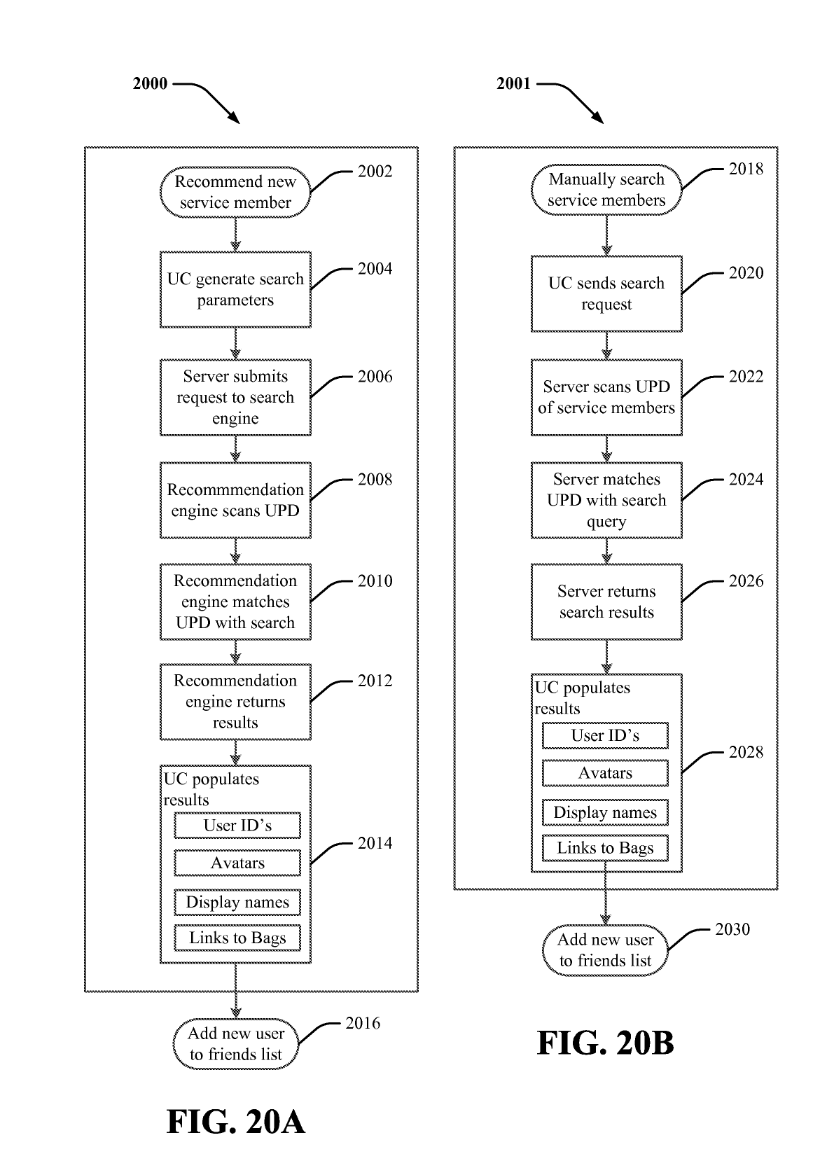

FIGS. 20A and 20B present flow diagrams illustrating the process of searching for a service member according to various embodiments. FIG. 20 presents a process 2000 employing a computer implemented recommendation engine. At 2002, an authorized user clicks Recommend new service members (with like interests) link/button. At 2004, the UC generates the search request parameters and sends it to the server. At 2006, the server delegates the request to a recommendation engine. At 2008, the recommendation engine scans user preference data of all SP members with “searchable,” and at 2010, matches it with requested search parameters and returns a results list at 2012. Then at 2014, the UC populates a sortable and filterable list for user review. In an aspect, recommended list includes users' ID's, avatars, service members display names, and links to user bags. At 2016, a user may select a service member from the list to offer friendship.

FIG. 20B presents a flow diagram 2001 illustrating the process of searching for a service member manually. At 2018, an authorized user enters a first, last or display name into a search box for manually searching for a service member and submits the query. At 2020, the UC sends the search request parameters to the server. At 2022, the server scans the user preference data of all SP members 2102 within the list according to the starting page from where the search request was generated. For example, if the search was executed from the friend's list page, the search is conducted only within that list. At 2024, the server matches user preference data with requested search parameters and returns results list 2026. Only those SP members with “searchable” statuses are searched. At 2028, the UC a populates sortable and filterable list for user review. Results list includes users' ID's, avatars, service members display names, and links to user bags.

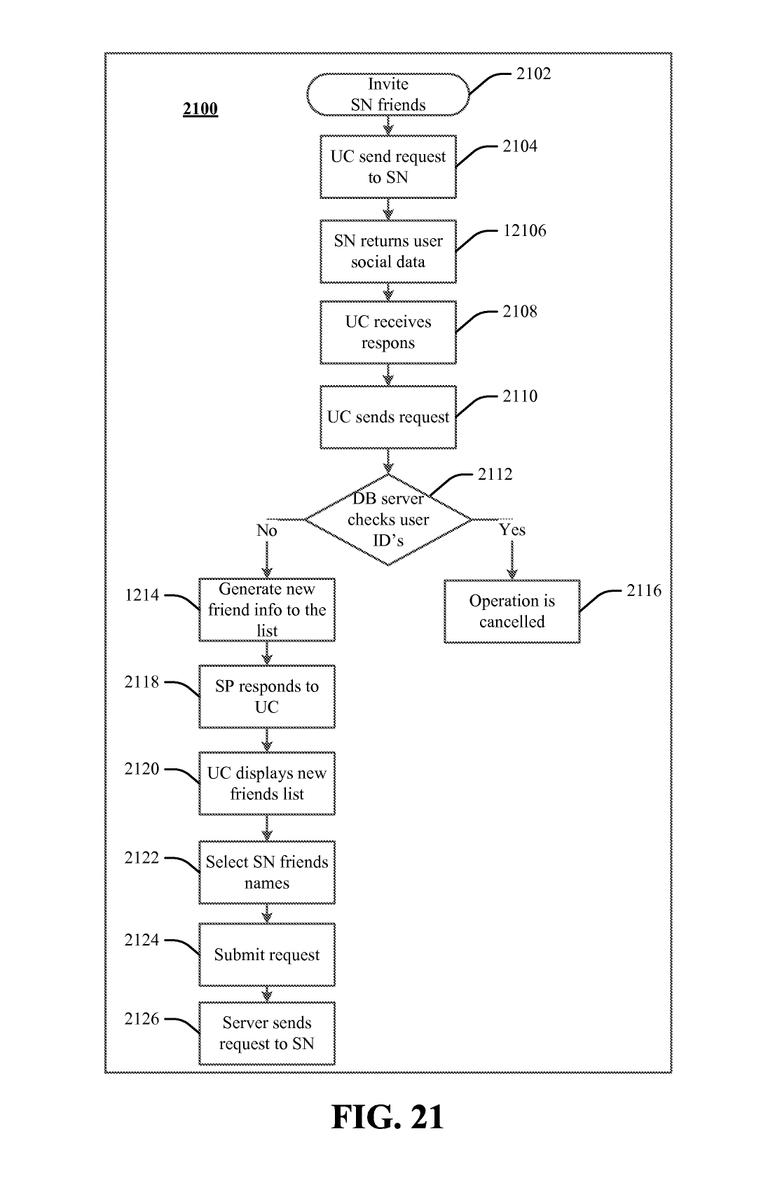

FIG. 21 presents a flow diagram 2100 illustrating the process of a user inviting an individual who is a friend on an external SN to join the SP network. According to one or more embodiments of the subject disclosure, after user links his/her affiliated SN profile(s) with his/her SP account profiles, the user may invite his/her SN friends to be friends in SP. With respect to process 2100, at the SP, the user clicks Invite SN friends link/button 2102. At 2104 the UC sends a request to an affiliated SN. At 2106, the SN returns response with the user social data, which includes SN user ID's and display names. At 2108, the UC receives the response and at 2110, sends a request to the SP database with every user ID from the list of SN user ID's list. At 2112, the SP database server checks that the results are not included in the friends list already. If all friends of the SN are already included in the SWP friends list of the user, a corresponding message is displayed and operation is cancelled at 2116. If all friends of the SN are not already included in the SP friends list of the user, at 2114 the server generates new friends' information to the list of SN friends of the SP. At 2118, the SP responds to the UC with the resulting list of new SN friends in SP. At 2120, the UC displays the list of new SN friends in SP to the user. At 2122, the user selects names to invite 2210 and at 2124, submits the invitation request. At 2126, the server sends the request to the SN. If invited friends accept the invitation, the user friends list is updated accordingly, and if not, a corresponding message is delivered into an inbox of the user messaging center.

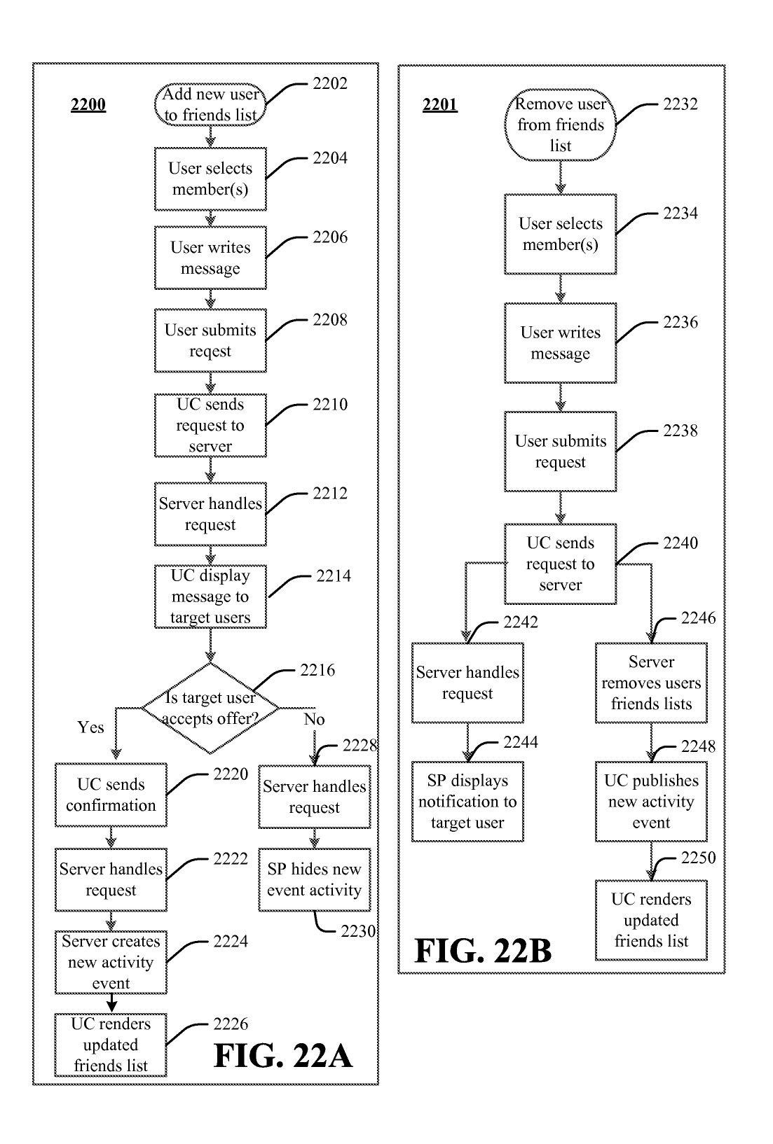

FIG. 22A presents a flow diagram 2200 illustrating a process of adding a user to a SP friends list in accordance with an embodiment. At 2202f user would like to add a new user to hid/her SP friends list he/she needs to selects that member at 2204. At 2206, the user optionally, writes a message, and clicks a “become my friend” to send the request at 2208. At 2210, the UC sends the request to the server with target user(s) user ID's and the message. At 2212, the server handles the request, generates a message and sends it to the target user(s) client(s). At 2214, the target UC(s) display personal message for target user with accept/reject link. If target user(s) accepts friendship offer at 2216, then the UC creates and sends request to the server with confirmation at 2220. At 2240 the server handles the request, adds target user(s) into friends list for source user, adds source user into friends list for target user(s) and responds with operation status. At 2242, the server creates a new activity event for sender and recipient with information about the friendship. At 2245, the UC renders an updated friends list. Looking back to step 2216, alternatively, if target user rejects friendship offer, at 2228 the server handles request and responds with operation status 2312. At 2230, a sender and recipient new activity event with information about the rejected friendship is not published by SP.

FIG. 22B presents a flow diagram 2201 illustrating a process of removing a user from a SP friends list in accordance with an embodiment. At 2232, if a user would like to remove a friend from his/her friends list, the user selects the friend at 2234, optionally write a message at 2236, and clicks a “remove” button/link to submit the request at 2238. At 2240, the UC sends the request to the server with target user(s) ID's and the message. At 2242, the server handles the request, generates a message and sends it to target users' client(s). At 2244, target user(s) client(s) display notification to the target user(s). In the meantime, at 2246, the server removes target user(s) from friends list of source user, removes source user from friends list for target user(s) and responds with operation status. At 2248, the new activity event with information about terminated friendship is not published at social activities list. At 2250, the UC renders an updated friends list.

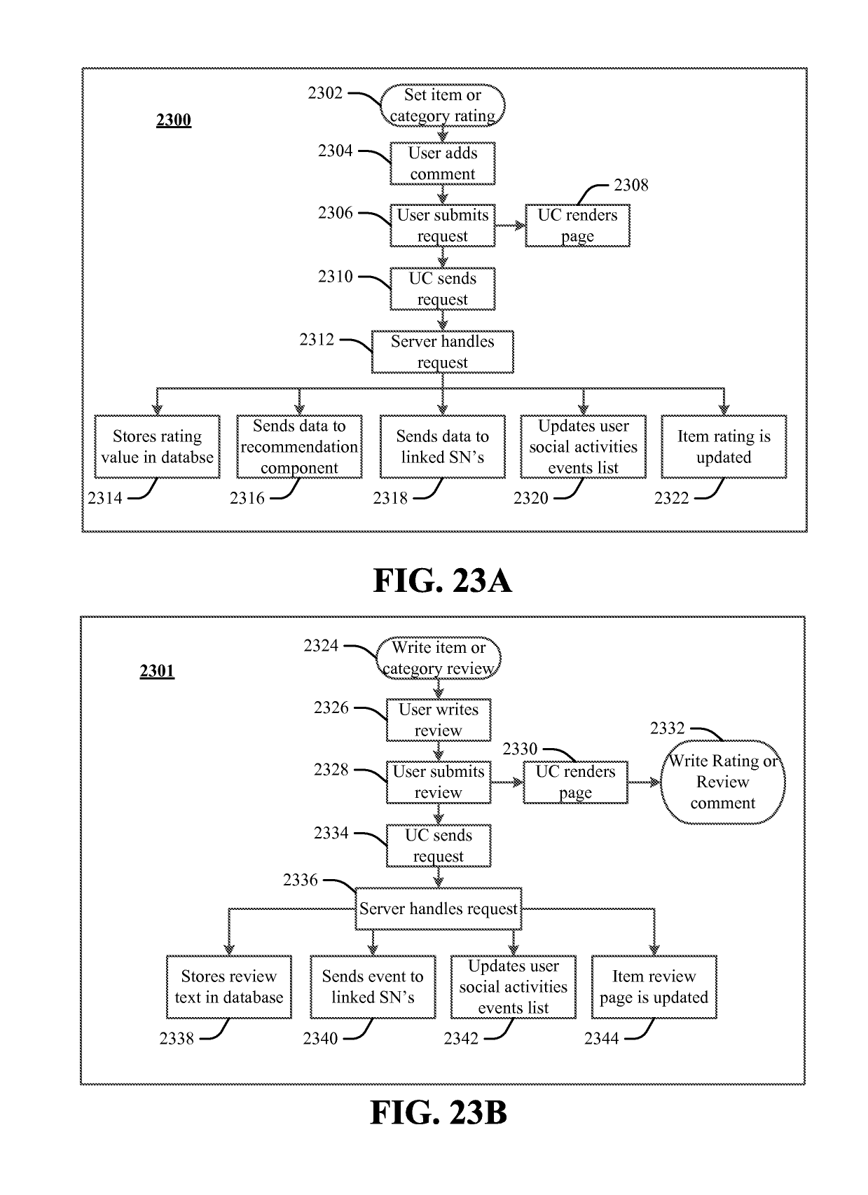

FIG. 23A presents a flow diagram 2300 illustrating a process of setting a rating of an item and item category in accordance with an embodiment. A logged in user may set an item or category rating at 2302 in a brief description or in item or category card. Then at 2304, the user may add optional comments. The UC does not display a set rating option to an unauthorized user. At 2306, the user submits the rating. At 2308, the UC renders a page with new user preference item data. At 2310, the UC sends a request to the SP server with the item's ID, rating value and comment. AT 2312, the server handles the request or stores the rating value for lazy calculation average rating in the server database 2314, sends the rating value to a recommendation engine 2316, if user has linked SN account, sends event information to the SN account 2318, updates the user social activities list 2320, and the item or item category rating is updated 2322. During the next periodically publishing procedure, new average rating shall be shown to guests and logged in users.

FIG. 23B presents a flow diagram 2301 illustrating a process of submitting a review of an item and item category in accordance with an embodiment. A logged in user may click submit item or category review link 2324 in a brief description or in an item or category card. A UC does not display the submit review link to an unauthorized user. At 2326, the user writes a review and at 2328, submits the review with visibility scope set to public. At 2330, the UC renders a page with new user preference item data. At 2332, commenting by other service member is permitted. At 2334, the UC sends a request to server with the item's ID and the review. At 2336, the server handles the request, i.e. stores the review in server database 2338, if user has linked SN account, sends event information to the SN 2340, updates social activities list with information about setting the review 2342, and the item or item category review list is updated at 2344. During the next periodically publishing procedure, new average rating shall be shown to guests and logged in users.

In accordance with an embodiment, options available for visibility scopes can include private, friends only and public. Setting visibility to private is similar in functionality to saving message as a draft. The content shall be available only to the message owner and later may be published for others to view. A message set to friends only visibility scope shall only be displayed to logged in and approved user's friends. Setting a message to public visibility scope displays the message to all logged in users of the SP.

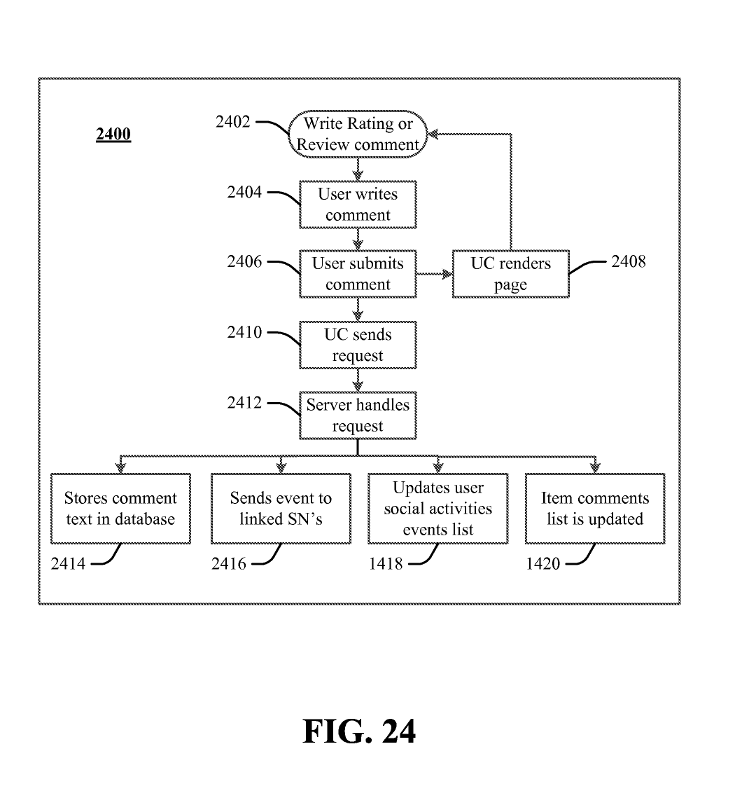

FIG. 24 presents a flow diagram 2400 illustrating a process of writing a comment to an item or item category review in accordance with an embodiment. At 2402, a logged in user may click submit comment to rating or review of an item, category or other comment link, in a brief description or in an item or category card. The UC does not display a submit review link to an unauthorized user. At 2404, the user writes and at 2406, submits a comment with visibility scope set to public. At 2408, the UC renders a page 2408 with new user preference item data. Commenting by other service member is permitted. At 2410, the UC sends a request to SP server with an item's ID and the comment. At 2412 the server handles the request, i.e. stores the review in server database 2414, if user has linked SN account, sends event information to the SN 2416, updates social activities list with information about setting the review 2418, and the item or item category review list is updated at 2420. During the next periodically publishing procedure, new average rating shall be shown to guests and logged in users.

One of ordinary skill in the art can appreciate that the various non-limiting embodiments of the shared shopping systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

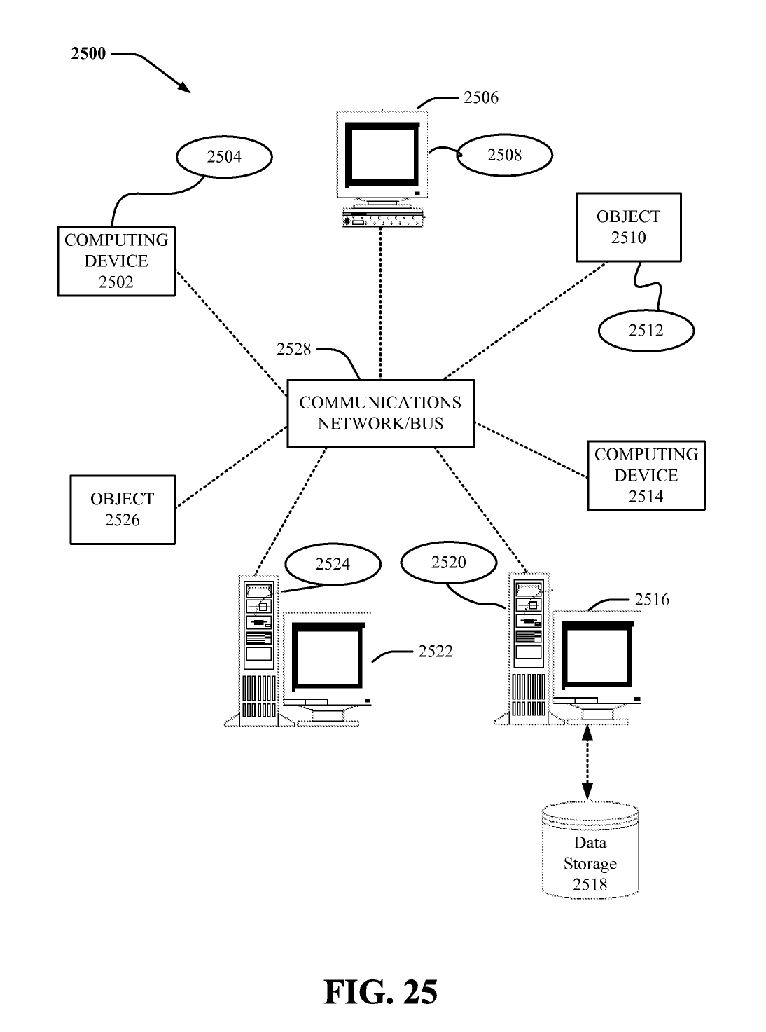

FIG. 25 provides a schematic diagram of an exemplary networked or distributed computing environment. The distributed computing environment comprises computing objects 2522, 2516, etc. and computing objects or devices 2502, 2506, 2510, 2026, 2514, etc., which may include programs, methods, data stores, programmable logic, etc., as represented by applications 2504, 2508, 2512, 2524, 2520. It can be appreciated that computing objects 2522, 2516, etc. and computing objects or devices 2502, 2506, 2510, 2026, 2514, etc. may comprise different devices, such as personal digital assistants (PDAs), audio/video devices, mobile phones, MP3 players, personal computers, laptops, etc.

Each computing object 2522, 2516, etc. and computing objects or devices 2502, 2506, 2510, 2026, 2514, etc. can communicate with one or more other computing objects 2522, 2516, etc. and computing objects or devices 2502, 2506, 2510, 2026, 2514, etc. by way of the communications network 2526, either directly or indirectly. Even though illustrated as a single element in FIG. 25, communications network 2526 may comprise other computing objects and computing devices that provide services to the system of FIG. 25, and/or may represent multiple interconnected networks, which are not shown. Each computing object 2522, 2516, etc. or computing object or device 2502, 2506, 2510, 2026, 2514, etc. can also contain an application, such as applications 2504, 2508, 2512, 2524, 2520, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 25, as a non-limiting example, computing objects or devices 2502, 2506, 2510, 2026, 2514, etc. can be thought of as clients and computing objects 2522, 2516, etc. can be thought of as servers where computing objects 2522, 2516, etc., acting as servers provide data services, such as receiving data from client computing objects or devices 2502, 2506, 2510, 2026, 2514, etc., storing of data, processing of data, transmitting data to client computing objects or devices 2502, 2506, 2510, 2026, 2514, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 2526 or bus is the Internet, for example, the computing objects 2522, 2516, etc. can be Web servers with which other computing objects or devices 2502, 2506, 2510, 2026, 2514, etc. communicate via any of a number of known protocols, such as the hypertext transfer protocol (HTTP). Computing objects 2522, 2516, etc. acting as servers may also serve as clients, e.g., computing objects or devices 2502, 2506, 2510, 2026, 2514, etc., as may be characteristic of a distributed computing environment.

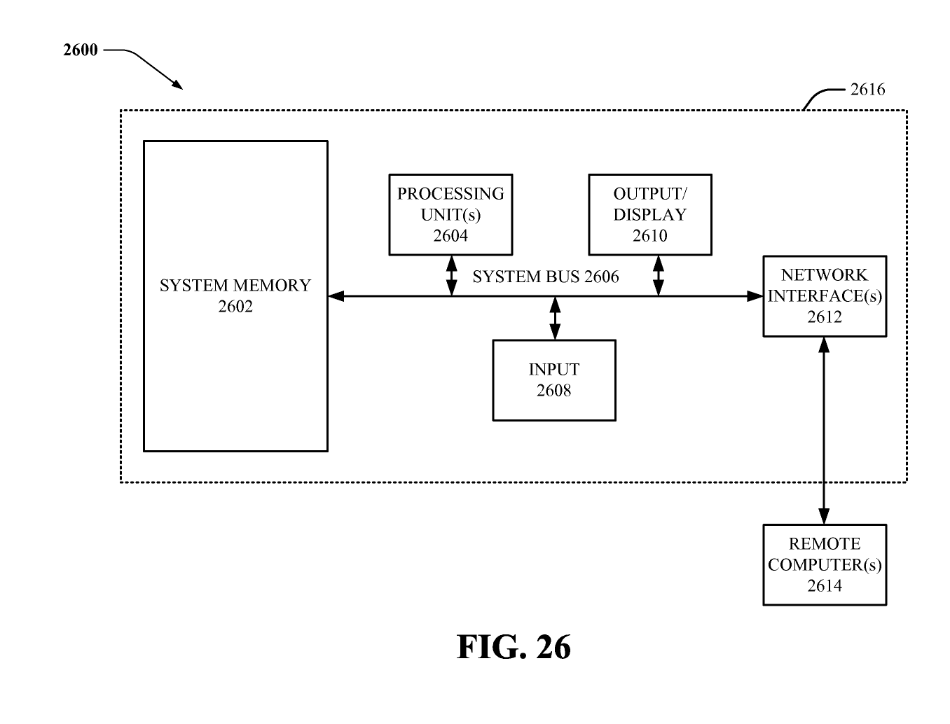

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 26 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 26 thus illustrates an example of a suitable computing system environment 2600 in which one or aspects of the non-limiting embodiments described herein can be implemented, although as made clear above, the computing system environment 2600 is only one example of a suitable computing environment and is not intended to suggest any limitation as to scope of use or functionality. Neither should the computing system environment 2600 be interpreted as having any dependency or requirement relating to any one or combination of components illustrated in the exemplary computing system environment 2600.

With reference to FIG. 26, an exemplary remote device for implementing one or more non-limiting embodiments includes a general purpose computing device in the form of a computer 2616. Components of computer 2616 may include, but are not limited to, a processing unit 2604, a system memory 2602, and a system bus 2606 that couples various system components including the system memory to the processing unit 2604.

Computer 2616 typically includes a variety of computer readable media and can be any available media that can be accessed by computer 2616. The system memory 2602 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 2602 may also include an operating system, application programs, other program modules, and program data.

A user can enter commands and information into the computer 2616 through input devices 2608. A monitor or other type of display device is also connected to the system bus 2606 via an interface, such as output interface 2612. In addition to a monitor, computers can also include other peripheral output devices such as speakers and a printer, which may be connected through output interface 2612.

The computer 2616 may operate in a networked or distributed environment using logical connections to one or more other remote computers, such as remote computer 2612. The remote computer 2612 may be a personal computer, a server, a router, a network PC, a peer device or other common network node, or any other remote media consumption or transmission device, and may include any or all of the elements described above relative to the computer 2616. The logical connections depicted in FIG. 26 include a network, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described infra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
storing, by at least one computing device, a plurality of data objects representative of a plurality of items for user consumption from an online merchant;
associating the plurality of data objects with context data including content data, user preference data and aggregated other user preference data; and
rendering a subset of the plurality of data objects based on the context data associated therewith.

2. The method of claim 1, further comprising, storing the context data by the at least one computing device.

3. The method of claim 2, further comprising, receiving new context data and dynamically updating the context data based on the new context data in response to the receiving.

4. The method of claim 1, further comprising:
filtering the plurality of data objects or the subset of the plurality of data objects based on at least one user defined criterion encompassed by the context data.

5. The method of claim 1, further comprising:
presenting each of the plurality of data objects of the subset with relative context data associated therewith.

6. The method of claim 1 wherein the user preference data includes at least one of a user rating or review for at least one of the plurality of data objects.

7. The method of claim 1, further comprising making an inference on behalf of the user to determine the user preference data based on at least one of a user profile or a social graph of the user.

8. The method of claim 7, further comprising:
receiving the social graph of the user from a data store managed by a social networking service.

9. The method of claim 1, wherein the aggregated other user preference data includes at least one of other user ratings or reviews for at least one of the plurality of data objects.

10. The method of claim 1, further comprising making an inference on behalf of the one or more other users to determine the aggregated user preference data based on at least one of one or more profiles of the other users or one or more social graphs of the other users.

11. A method, comprising:
accessing, by at least one computing device, a plurality of data objects representative of a plurality of items for consumption by a user from an online merchant, wherein each of the plurality of data objects are associated with context data including content data, user preference data and aggregated other user preference data;
requesting a first subset of the plurality of data objects based on the context data; and
receiving a computer generated output including the first subset of the plurality of data objects.

12. The method of claim 11, further comprising dynamically updating the context data based on new context data in response to receiving the new context data.

13. The method of claim 11, further comprising:
selecting at least one searchable criterion related to the context data;
requesting a second subset of the plurality of data objects based on the at least one searchable criterion; and
wherein the receiving the computer generated output includes receiving the second subset of the plurality of data objects.

14. The method of claim 11, further comprising:
selecting at least one searchable criterion related to the context data;
requesting a second subset of the first subset of the plurality of data objects based on the at least one searchable criterion; and
wherein the receiving the computer generated output includes receiving the second subset of the plurality of data objects.

15. The method of claim 11, further comprising:
selecting at least one data object and receiving the context data associated therewith.

16. The method of claim 11, further comprising, providing the user preference data by:
selecting at least one data object from the first subset; and
submitting at least one of a rating or a review the item associated with the at least one data object.

17. The method of claim 11, wherein the user preference data includes data related to an affinity of the user for an item based on at least one of a profile of the user or a social graph of the user.

18. The method of claim 17, further comprising:
providing access to social graph information for the social graph of the user from a data store managed by a social networking service.

19. The method of claim 11 wherein the aggregated other user preference data includes at least one of other user ratings or reviews for at least one of the plurality of data objects.

20. The method of claim 11, wherein the aggregated other user preference data includes data related to at least one affinity of at least one other user for an item based on at least one of a profile for the at least one other user or a social graph for the at least one other user.

21. A system, comprising:
a data store configured to store a plurality of data objects representative of a plurality of items for consumption by a user from an online merchant, wherein each of the plurality of data objects include context data including content data, user preference data and aggregated other user preference data; and
a recommendation component configured to generate a subset of the plurality of data objects based on the context data.

22. The system of claim 21, further comprising:
an update component configured to receive new context data and dynamically update the context data in the data store based on the new context data.

23. The system of claim 21, further comprising:
a filter component configured to filter the plurality of data objects or the subset of the plurality of data objects based on at least one user defined criterion.

24. The system of claim 21, further comprising:
a presentation component configured to present each of the plurality of data objects of the subset with the relative context data associated therewith.

25. The system of claim 21, wherein the user preference data includes at least one of a user rating or review for at least one of the plurality of data objects.

26. The system of claim 21, further comprising an inference component configured to make an inference on behalf of the user to determine the user preference data based on at least one of a user profile or a user social graph.

27. The system of claim 21, wherein the aggregated other user preference data includes at least one of other user ratings or reviews for at least one of the plurality of data objects.

28. The system of claim 21, further comprising an inference component configured to make an inference on behalf of the one or more other users to determine the aggregated user preference data based on at least one of one or more profiles or social graphs of other users.

29. A computer readable storage medium comprising computer executable instructions that, in response to execution by a computing system, cause the computing system to perform operations, comprising:
storing, by at least one computing device, a plurality of data objects representative of a plurality of items for user consumption from an online merchant;
associating each of the plurality of data objects with context data including content data, user preference data and aggregated other user preference data;
generating a subset of the plurality of data objects based on the context data.

30. The computer readable storage medium of claim 29, the operations further comprising, storing the context data by the at least one computing device.

31. The computer readable storage medium of claim 30, the operations further comprising, receiving new context data and dynamically updating the context data based on the new context data in response to the receiving.

32. The computer readable storage medium of claim 29, the operations further comprising filtering the plurality of data objects or the subset of the plurality of data objects based on at least one user defined criterion.

33. The computer readable storage medium of claim 29, the operations further comprising, presenting each of the plurality of data objects of the subset with the relative context data associated thereto.

34. The computer readable storage medium of claim 29, wherein the user preference data includes at least one of a user rating or review for at least one of the plurality of data objects.

35. The computer readable storage medium of claim 29, the operations further comprising making an inference on behalf of the user to determine the user preference data based on at least one of a user profile or a user social graph.

36. The computer readable storage medium of claim 29, wherein the aggregated other user preference data includes at least one of other user ratings or reviews for at least one of the plurality of data objects.

37. The computer readable storage medium of claim 29, the operations further comprising making an inference on behalf of the one or more other users to determine the aggregated user preference data based on at least one of one or more profiles or social graphs of the one or more other users.

38. A system comprising:
means for accessing, a plurality of data objects representative of a plurality of items for user consumption from an online merchant, wherein each of the plurality of data objects are associated with context data including content data, user preference data and aggregated other user preference data;
means for requesting a first subset of the plurality of data objects based on the context data; and
means for outputting the first subset of the plurality of data objects.

39. A method, comprising:
storing by a computing device, a plurality of data objects representative of a plurality of items for user consumption from an online merchant;
registering a device associated with a user with the online merchant; and in response to registering the device:
associating the device with at least one other device registered with the online merchant associated with an other user in response to selection of the at least one other device by the device;
monitoring a first social activity of the at least one other device, wherein the first social activity includes a first activity related to an interaction of the at least one other device with at least one of the plurality of data objects; and
collecting and storing first social activity data related to the first social activity of the at least one other device.

40. The method of claim 39, further comprising:
generating a subset of the plurality of data objects based on the first social activity data.

41. The method of claim 39, further comprising, providing the device access to the first social activity data.

42. The method of claim 39, further comprising:
monitoring at least a second social activity of the at least one other device, wherein the at least the second social activity includes a second activity related to an interaction by the at least one other device with at least one of the plurality of data objects;
collecting and storing second social activity data related to the social activity of the at least one other registered device;
associating the first social activity data with a first social weight and the at least second social activity data with a second social weight;
calculating an aggregated social activity weight based on the sum of the first social weight and the second social weight; and
generating a subset of the plurality of data objects based on the aggregated social activity weight.

43. The method of claim 39, wherein the monitoring the first social activity of the at least one other registered device includes monitoring at least one of when the at least one data object is rated by the at least one other device, when the at least one data object is favored by the at least one other device, when the at least one data object is disfavored by the at least one other device, when a data object is reviewed by the at least one other device, or when a data object is purchased by the at least one other device.

44. The method of claim 39, wherein the registering the device further comprises verifying the registration of the device through an external network affiliated with the online merchant.

45. The method of claim 39, wherein the associating the registered device with the at least one other device comprises:
comparing preference data associated with the device and multiple registered devices including the at least one other device, and identifying at least one similarity in the preference data for the device and the at least one other device.

46. A method, comprising:
accessing, by a computing device associated with a user, a plurality of data objects representative of a plurality of items for user consumption from an online merchant;
registering the computing device associated with the online merchant, and in response to the registering:
selecting by the computing device, at least one other device registered with the online merchant associated with an other user as friend;
requesting a first subset of the plurality of data objects based on first social activity data, wherein the first social activity data includes data related to a first activity of an interaction by the least one other device with at least one of the plurality of data objects; and
outputting the first subset.

47. The method of claim 46, further comprising
requesting a second subset of the plurality of data objects based on the first social activity data and second social activity data, wherein the second social activity data includes data related to a second activity of an interaction by the least one other device with at least one of the plurality of data objects; and
wherein the outputting includes outputting the subset of the plurality of data objects based on the first social activity data and the second social activity data.

48. The method of claim 46, further comprising, viewing the first social activity data with the computing device.

49. The method of claim 46, wherein the requesting the first subset of the plurality of data objects based on the first social activity data includes requesting data related to at least one of when the at least one data object is rated by the at least one other device, when the at least one data object is favoured by the at least one other device, when the at least one data object is disfavoured by the at least one other device when a data object is reviewed by the at least one other device, or when a data object is purchased by the at least one other device.

50. The method of claim 46, wherein the selecting the at least one other device comprises sending a request to the at least one other device to become a friend of the computing device and receiving acceptance of the request.

51. The method of claim 46, wherein the selecting the at least one other device comprises receiving a recommendation to select the at least one other device based on a comparison of preference data associated with the computing device and the other device.

52. The method of claim 46, further comprising:
sending a request to an unregistered device associated with an unregistered user to become a registered user.

53. The method of claim 46, further comprising:
sending a message to the at least one other device comprising at least one of a rating or a review of at least one of the plurality of data objects.

54. A system comprising:
data storage configured to store a plurality of data objects representative of a plurality of items for user consumption from an online merchant;
an authorization component configured to register a device associated with a user of the online merchant;
a friend component configured to associate the registered device with at least one other device registered with the online merchant associated with an other user in response to selection of the at least one other device by the device; and
a monitoring component configured to monitor social activities of the at least one other device, wherein the social activities include different social activities related to an interaction by the at least one other device with at least one of the plurality of data objects, the monitoring component further configured to collect and store social activity data related to each of the different social activities monitored.

55. The system of claim 54, further comprising:
a recommendation component configured to generate a subset of the plurality of data objects based on at least a part of the social activity data.

56. The system of claim 54, wherein the recommendation component is further configured to:
apply a different social weight value to the social activity data for each of the different social activities monitored;
calculate an aggregated social activities weight value based on a sum of the different social weight values; and
employ a computer to generate a subset of the plurality of data objects based on the aggregated social activities weight value.

57. The system of claim 54, wherein the monitoring component is configured to monitor at least one of when the at least one data object is rated by the at least one other device, when the at least one data object is favoured by the at least one other device, when the at least one data object is disfavoured by the at least one other device when a data object is reviewed by the at least one other device, or when a data object is purchased by the at least one other device.

58. The system of claim 54, wherein the friend component is further configured to:
compare preference data associated with the device and multiple registered devices including the at least one other device;
identify at least one similarity in the preference data for the device and the at least one other device; and
in response to the identification of the at least one similarity, facilitate associating the registered device with the at least one other device.

59. A computer readable storage medium comprising computer executable instructions that, in response to execution by a computing system, cause the computing system to perform operations, comprising: comprising:
accessing by a computing device associated with a user, a plurality of data objects representative of a plurality of items for user consumption from an online merchant;
registering the device associated with the online merchant; and in response to registering:
selecting at least one other device registered with the online merchant associated with an other user as friend;
requesting a first subset of the plurality of data objects based on first social activity data, wherein the first social activity includes data related to a first activity of an interaction by the least one other device with at least one of the plurality of data objects; and
receiving a computer generated output comprising the first subset of the plurality of data objects based on the first social activity data.

60. The computer readable storage medium of claim 59, the operations further comprising:
requesting a second subset of the plurality of data objects based on the first social activity data and at least second social activity data, wherein the second social activity includes data related to a second activity of an interaction by the least one other device with at least one of the plurality of data objects; and
wherein the receiving the computer generated output includes receiving the second subset.

61. A system comprising:
means for storing a plurality of data objects representative of a plurality of items for user consumption from an online merchant;
means for registering a device associated with a user with the online merchant;
means for associating the registered device with at least one other device registered with the online merchant associated with an other user in response to selection of the at least one other device by the device; and
means for monitoring social activities of the at least one other device, wherein the social activities include different social activities related to an interaction by the at least one other device with at least one of the plurality of data objects, the monitoring component further configured to collect and store social activity data related to each of the different social activities monitored.
